(19) United States
(12) Patent Application Publication
(10) Pub. No.: US 2020/0143337 A1
(43) Pub. Date: May 7, 2020

(54) SECURE COMPUTER NETWORK-BASED PLATFORM

(71) Applicant: Figure Technologies, Inc., San Francisco, CA (US)

(72) Inventors: Larry Matthew Conroy, Boulder, MT (US); Jason Davidson, Helena, MT (US)

(21) Appl. No.: 16/179,832

(22) Filed: Nov. 2, 2018

(51) Int. Cl. G06Q 20/06; G06Q 20/38; G06F 16/182; H04L 9/08; H04L 9/06; G06Q 40/06

(52) U.S. Cl. CPC G06Q 20/065; G06Q 20/382; G06F 16/1824; H04L 2209/56; H04L 9/0643; G06Q 40/06; H04L 2209/38; H04L 9/0861

(57) ABSTRACT

A blockchain system may include nodes, member network entities, and a protocol entity. The nodes together are configured to maintain an immutable record as a blockchain, based on commands provided by the protocol entity. A member may provide a request for a transaction to the protocol entity to perform an operation along with encrypted data. For example, the operation may include a transaction. The protocol entity may invoke a smart contract at one or more nodes to perform the operation on the encrypted data. In response, the node decrypts the encrypted data using a decryption key stored in the node storage equipment to generate cleartext data. The node then performs the operation based on the cleartext data and secures the cleartext data. The immutable record of the blockchain to be updated based on the operation. For example, the secured data and audience permission information may be added to the blockchain.

The present disclosure is directed towards a computer network-based platform having data security features for processing transactions.

### BACKGROUND

Conventional network topologies and infrastructures provide capabilities for implementing platforms for executing simple transactions. For example, a conventional blockchain network can be used as a ledger to maintain a database of cryptocurrency holdings. These types of networks are not suitable, nor are they capable, of functioning as platforms for performing complex transactions, including, for example, complex financial transactions.

Financial asset classes require some combination of custody, trustee and administrative functions that are not accretive to the asset originator or investor. Intermediaries can add significant cost and latency to transactions involving asset classes. Each class is often burdened with aspects of illiquidity, opaqueness, additional cost, and risk. For example, non-securitized loans have no formal trading platform, and accordingly trades can take up to 100 days or more to settle. Securitization is burdened with audit, underwriting and trustee fees. Stocks typically require expensive custody and transfer infrastructure. Corporate bonds can have limited pricing transparency. Pooled investment vehicles typically require trust, custodial and administrative fees. Exchanges, when available for an asset class, may charge for providing liquidity.

### SUMMARY

The present disclosure provides a method for securely performing an operation in a node of a blockchain system. The blockchain system comprises a plurality of nodes of which the node is one, each of the plurality of nodes comprising respective node computing equipment comprising node storage equipment. Each of the plurality of nodes further comprise respective node communications equipment. The blockchain system further comprises a plurality of member network entities, each of the plurality of members comprising respective member computing equipment. The blockchain system further comprises a protocol entity comprising protocol entity computing equipment. The blockchain system further comprises a computer network coupling the nodes, the member network entities, and the protocol entity, wherein each respective node storage equipment of the plurality of nodes together are configured to maintain an immutable record as a blockchain. The method comprises receiving from the protocol entity, using node communications equipment, a request to perform an operation associated with at least one of the plurality of member network entities. The method further comprises performing, using node computing equipment, in an isolated computing environment of the node, the operation using encrypted data stored in node storage equipment of the node, wherein the encrypted data was encrypted using a data encryption key. Performing the operation comprises decrypting, using the node computing equipment, the encrypted data to generate cleartext data. Performing the operation further comprises performing, using the node computing equipment, the operation based on the cleartext data. Performing the operation further comprises encrypting, using the node computing equipment, the cleartext data. The method further comprises causing the immutable record of the blockchain to be updated based on the operation.

The present disclosure provides a node of a blockchain system for securely performing an operation. The node comprises node computing equipment comprising node storage equipment. The node further comprises node communications equipment for communicatively coupling over a computer network to a plurality of member network entities, a protocol entity, and at least one other node comprising respective node computing equipment, which comprise respective other node storage equipment. Each of the node storage equipment and respective other node storage equipment of the at least one other node are together configured to maintain an immutable record as a blockchain. The node communications equipment is configured to receive from the protocol entity a request to perform an operation associated with at least one of the plurality of member network entities. The node computing equipment is configured to perform, in an isolated computing environment, the operation using encrypted data stored in the node storage equipment, wherein the encrypted data was encrypted using a data encryption key. Being configured to perform the operation comprises being configured to decrypt the encrypted data to generate cleartext data, to perform the operation based on the cleartext data, and to encrypt the cleartext data. The node computing equipment is further configured to cause the immutable record of the blockchain to be updated based on the operation.

The present disclosure provides a non-transitory computer readable medium having instructions programmed thereon for performing a method for securely performing an operation in a node of a blockchain system. The blockchain system comprises a plurality of nodes of which the node is one, each of the plurality of nodes comprising respective node computing equipment comprising node storage equipment. Each of the plurality of nodes further comprises respective node communications equipment. The blockchain system further comprises a plurality of member network entities, each of the plurality of members comprising respective member computing equipment. The blockchain system further comprises a protocol entity comprising protocol entity computing equipment. The blockchain system further comprises a computer network coupling the nodes, the member network entities, and the protocol entity, wherein each respective node storage equipment of the plurality of nodes together are configured to maintain an immutable record as a blockchain. The method comprises receiving from the protocol entity, at the node, a request to perform an operation associated with at least one of the plurality of member network entities. The method further comprises performing, in an isolated computing environment of the node, the operation using encrypted data stored in node storage equipment of the node, wherein the encrypted data was encrypted using a data encryption key.

Performing the operation comprises decrypting the encrypted data to generate cleartext data, performing the operation based on the cleartext data, and encrypting the cleartext data. The method further comprises causing the immutable record of the blockchain to be updated based on the operation.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

FIG. 1 shows a block diagram of an illustrative system for providing ledger, registry, and exchange functionality, in accordance with some embodiments of the present disclosure;

FIG. 2 shows a block diagram of an illustrative system having a plurality of nodes and a plurality of members, in accordance with some embodiments of the present disclosure;

FIG. 3 shows a block diagram of an illustrative system for buying and selling value tokens, in accordance with some embodiments of the present disclosure;

FIG. 4 shows a flowchart of an illustrative process for buying and selling value tokens, in accordance with some embodiments of the present disclosure;

FIG. 5 shows a block diagram of an illustrative system for buying and selling value tokens, in accordance with some embodiments of the present disclosure;

FIG. 6 shows a flowchart of an illustrative process for buying and selling value tokens, in accordance with some embodiments of the present disclosure;

FIG. 7 shows a block diagram of an illustrative system for originating a loan, in accordance with some embodiments of the present disclosure;

FIG. 8 shows a flowchart of an illustrative process for originating a loan, in accordance with some embodiments of the present disclosure;

FIG. 9 shows a block diagram of an illustrative system for originating a loan, in accordance with some embodiments of the present disclosure;

FIG. 10 shows a flowchart of an illustrative process for originating a loan, in accordance with some embodiments of the present disclosure;

FIG. 11 shows a block diagram of an illustrative system for managing a loan payment, in accordance with some embodiments of the present disclosure;

FIG. 12 shows a flowchart of an illustrative process for managing a loan payment, in accordance with some embodiments of the present disclosure;

FIG. 13 shows a block diagram of an illustrative system for managing a loan payment, in accordance with some embodiments of the present disclosure;

FIG. 14 shows a flowchart of an illustrative process for managing a loan payment, in accordance with some embodiments of the present disclosure;

FIG. 15 shows a block diagram of an illustrative system for managing loans, in accordance with some embodiments of the present disclosure;

FIG. 16 shows a flowchart of an illustrative process for buying or selling a loan, in accordance with some embodiments of the present disclosure;

FIG. 17 shows a flowchart of an illustrative process for financing a loan, in accordance with some embodiments of the present disclosure;

FIG. 18 shows a block diagram of an illustrative system for securitizing a loan, in accordance with some embodiments of the present disclosure;

FIG. 19 shows a flowchart of an illustrative process for securitizing a loan, in accordance with some embodiments of the present disclosure;

FIG. 20 shows a block diagram of an illustrative system for securitizing a loan, in accordance with some embodiments of the present disclosure;

FIG. 21 shows a flowchart of an illustrative process for securitizing a loan, in accordance with some embodiments of the present disclosure;

FIG. 22 shows a block diagram of an illustrative system for managing a transaction, in accordance with some embodiments of the present disclosure;

FIG. 23 shows a flowchart of an illustrative process for managing a transaction using a blockchain system, in accordance with some embodiments of the present disclosure;

FIG. 24 shows a block diagram of an illustrative system for encrypting information from a member, in accordance with some embodiments of the present disclosure;

FIG. 25 shows a block diagram of an illustrative system for processing encrypted information within a smart contract, in accordance with some embodiments of the present disclosure;

FIG. 26 shows a block diagram of an illustrative arrangement for a blockchain system using an isolated computing environment, in accordance with some embodiments of the present disclosure;

FIG. 27 shows a block diagram of an illustrative arrangement for transacting using a blockchain system, in accordance with some embodiments of the present disclosure;

FIG. 28 shows a flowchart of an illustrative process for managing an operation of a blockchain system, in accordance with some embodiments of the present disclosure;

FIG. 29 shows a flowchart of an illustrative process for performing an operation in an isolated computing environment, in accordance with some embodiments of the present disclosure; and

FIG. 30 shows a block diagram of an illustrative network arrangement for a blockchain system, in accordance with some embodiments of the present disclosure.

### DETAILED DESCRIPTION

The present disclosure is directed to a platform distributed over a network. The platform serves as a ledger, registry, and exchange, built on an underlying blockchain-based architecture.

In some embodiments, a protocol entity governs a blockchain system that provides ledger functionality, registry functionality, and exchange functionality. Ledger functionality may include transaction servicing such as, for example, executing smart contracts to manage payments. In some embodiments, because transactions are managed accordingly to information immutably stored on the blockchain, real-time performance may be achieved. Registry functionality may include features involving ownership determination such as, for example, recording and conveying title to assets. In some embodiments, because ownership information is included in the blockchain, and may be determined solely by the blockchain, latency and discrepancies may be reduced or eliminated. Exchange functionality may include providing asset liquidity such as, for example, tokenization of assets and more transparent price discovery. In some embodiments, because assets may be tokenized, fractionalized sales may be achieved.

The blockchain system of the present disclosure is governed by the protocol entity. Actions performed on the blockchain system include transactions submitted through application programming interfaces (APIs). The blockchain system include any suitable number of nodes that may be defined according to any suitable criteria, such as a proof of work (PoW), proof of stake (PoS), any other suitable criteria, or any combination thereof. For purposes of brevity and clarity, and not be way of limitation, the present disclosure is discussed in the context of nodes be stakeholders through a PoS paradigm. The blockchain system include entities that originate transactions, referred to herein as members. The blockchain system may also include one or more dedicated market makers, who define the market for the blockchain system's value tokens. In some embodiments, the role of market maker may be defined through an value-token exchange integrated into the blockchain system in which, for example, members define the market of the value tokens through exchange participation.

It will be understood that the nodes, the protocol entity, members, and market makers are network entities, with nodes defining the distributed network of the blockchain system. In some embodiments, nodes host smart contracts that determine the legitimacy of a transaction. In some embodiments, nodes store an immutable, time-stamped hash of data resulting from smart contracts. In some embodiments, nodes are paid value tokens to host smart contracts and data. In some embodiments, nodes may put up a stake of value tokens for the right to perform this function (e.g., host smart contracts) as part of the PoS. In some embodiments, nodes do not validate transactions themselves, nor are they privy to unencrypted data being submitted on the blockchain.

The protocol entity is responsible for granting permissions (e.g., for transactions) to members. In some embodiments, the protocol entity is configured to create smart contracts related to these permissions for each node to process and store transactions. In some embodiments, the protocol entity is configured to determine the cost (e.g., a fee in value tokens) for a member to submit a transaction on the protocol or to otherwise use the protocol. In some embodiments, the protocol entity is configured to determine the amount of stake that nodes must hold (e.g., the nodes' buy-in for PoS). In some embodiments, there is only one protocol entity, governed by value token holders (e.g., by majority vote or other mechanism). In some embodiments, the protocol entity is configured to on-board members, perform diligence, and other suitable functions. For example, the protocol entity may perform know-your-customer (KYC) and anti-money-laundering (AML) analysis of members.

Members, also referred to herein as member network entities, include entities that submit transactions through the protocol entity. In some embodiments, members pay value tokens to use or otherwise have access to the blockchain system. In some circumstances, members may also be nodes. In some embodiments, members may have private conversations through the blockchain system between themselves (e.g., unknown to the protocol entity or nodes) that are not made part of the immutable record (e.g., held by nodes). Members may be associated with, for example, institutions, individuals, or both.

A market maker, also referred to herein as a market maker member (MMM), is configured to generate and maintain a market between fiat and value tokens (e.g., determining an exchange rate). The market maker may also facilitate securitization of relatively illiquid assets, by managing the exchange rate of value tokens to fiat. The blockchain system may include one or more market makers. In some embodiments, a member may act as a market maker. In some embodiments, there may exist a limited number of market makers authorized to manage an exchange market between one or more types of fiat and one or more value tokens.

Bank members include members that manage or maintain financial accounts of members (e.g., market makers or otherwise), users, any other suitable entities. In some embodiments, bank members provide confirmation of funds (e.g., fiat as opposed to value tokens), transfer of funds, reception of funds (e.g., a payment or a deposit), disbursement of funds (e.g., from withdrawal), escrow of funds, buying value tokens with fiat, selling value tokens for fiat, any other suitable function for managing fiat, or any suitable combination thereof

Providers, as referred to herein, include non-member, non-node entities that provide information, provide documentation, provider verification, or otherwise provide assistance to a transaction. In some embodiments, a provider may be allowed to communicate only with the protocol entity. For example, a provider may include an appraisal consultant, who is commissioned to submit an appraisal report to the protocol entity. In a further example, a provider may include a local municipality that provides a certification of habitability, utility, safety, compliance, any other suitable condition upon which a transaction may be contingent, or any suitable combination thereof. In a further example, a provider may include a governmental entity that provides a certification of compliance in a procedure, condition, or other aspect of a transaction. In a further example a provider may include a credit evaluator (e.g., a credit reporting agency), an institution that provides reporting, an auditor, or any other entity that provides reporting information.

Users, as referred to herein, include entities that enter into transactions from with one or more members. For example, a user may include an individual desiring to obtain a mortgage loan or make a loan payment. The term user, as used herein, shall refer to a non-member, non-node entity. Accordingly, a member that enters into a transaction with another member is not a user.

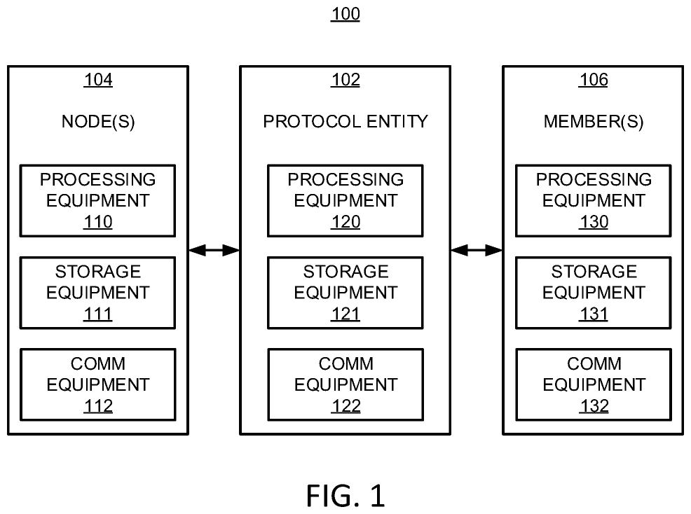

FIG. 1 shows a block diagram of a generalized, high level, illustrative blockchain system 100 for providing ledger, registry, and exchange functionality, in accordance with some embodiments of the present disclosure. System 100 and any of the various other embodiments of blockchain systems presented herein may be used to implement the functionalities, processes, and features described herein. System 100 includes protocol entity 102, one or more nodes 104, and one or more members 106. In some embodiments, system 100 implements a blockchain system, configured to store an immutable record among nodes 104. Members 106 may be associated with individuals, institutions, or both such as, for example, investors, banks, credit unions, investment funds, any other suitable entities, or any suitable combination thereof. In some embodiments, member(s) 106 may initiate or request transactions from protocol entity 102, which may in turn generate a smart contract to be executed by node(s) 104. In some embodiments, member(s) 106 may alert protocol entity 102 of a transaction, and protocol entity 102 may in turn generate a smart contract to be executed by node(s) 104. In some embodiments, node(s) 104 store a record of, and confirm, the transactions. For example, node(s) 104 may store an immutable record in the form of a blockchain. In a further example, node(s) 104 may confirm a record of transactions stored in the blockchain to provide confidence.

In some embodiments, protocol entity 102 is configured to generate smart contracts, generate rules, receive information from members, manage security features (e.g., public-private keys, passcodes, authentications), manage permissions (e.g., which entities have access to information and the condition of that information), perform any other function for managing the blockchain system, or any suitable combination thereof. In some embodiments, node(s) 104 are configured to receive data (e.g., encrypted or cleartext), receive smart contracts (e.g., which may include data), store records (e.g., related to transactions, ownership, balances, compliance information, any other suitable subject, or any combination thereof), any other suitable function, or any suitable combination thereof.

In some embodiments, a value token may be used as currency (e.g., as a native token to the blockchain system) within the blockchain system in accordance with the protocol defined by the protocol entity. In some embodiments, member(s) 106 pay value tokens to transact on or otherwise use the blockchain system For example, member(s) 106 may transfer value tokens they possess, which are then distributed to node(s) 106, protocol entity 102, other members, or any combination thereof. In some embodiments, value tokens are used to demonstrate, and record as part of the blockchain, a transfer of value (e.g., between parties).

Each of node(s) 104 may include processing equipment 110, storage equipment 111, and communications (comm) equipment 112. Protocol entity 102 may include processing equipment 120, storage equipment 121, and communications (comm) equipment 122. Each of member(s) 106 may include processing equipment 130, storage equipment 131, and communications (comm) equipment 132. Processing equipment is configured to execute commands, perform operations, host an operating system, and otherwise process information. For example, processing equipment may include one or more processors and communications buses. Storage equipment (e.g., memory) is configured to store information (e.g., for subsequent recall and/or modification). Communications equipment is configured to transmit and receive signals, as well as interface to one or more networks.

Any or each of processing equipment 110, 120, and 130, storage equipment 111, 121, and 131, and comm equipment 112 may be implemented using any suitable software, hardware, or both. Components of node(s) 104, protocol entity 102, and member(s) 106 may be implemented locally in one or more respective client and/or server computing environments, remotely in one or more cloud environments (or any other suitable remote or distributed computing environments), or any combination thereof. In some embodiments certain of the components of blockchain system 100 that are indicated as being distinct may be implemented in a single centralized arrangement.

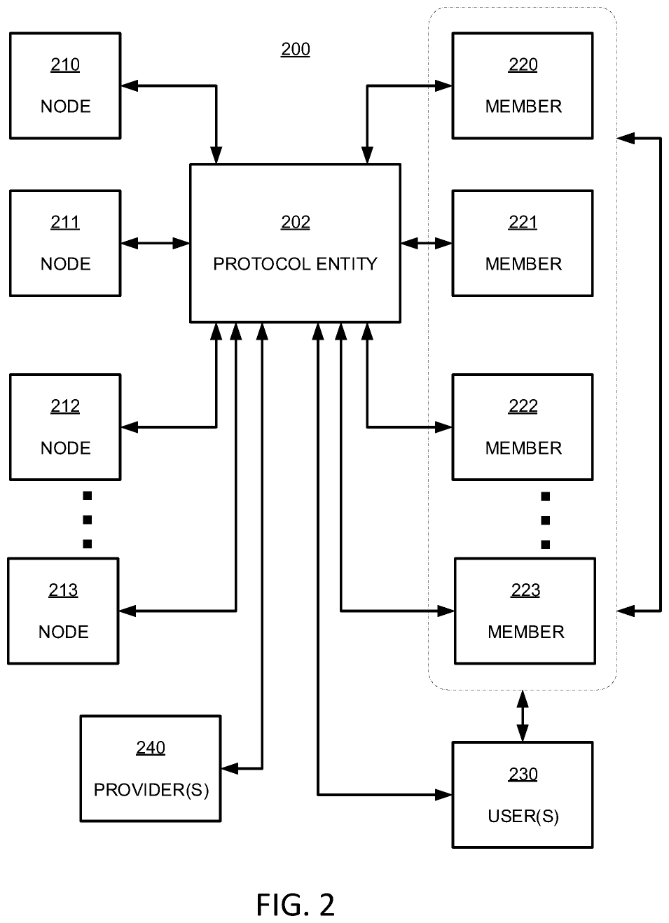

FIG. 2 shows a block diagram of illustrative blockchain system 200 having a plurality of nodes 210, 211, 212, and 213 and a plurality of members 220, 221, 222, and 223, in accordance with some embodiments of the present disclosure. User(s) 230 and provider(s) 240 may also interact with system 200. In some embodiments, system 200 implements a blockchain system configured to store an immutable record among nodes 210-213. Members 220-223 may be associated with individuals, institutions, or both such as, for example, investors, banks, market makers, credit unions, investment funds, any other suitable entities, or any suitable combination thereof. Any of members 220-223 may initiate or request transactions from protocol entity 202, which is configured to generate smart contracts to be executed by any or all of nodes 210-213. For example, in some embodiments, each smart contract is executed by each node (e.g., all nodes endorse transactions before each new block is included the blockchain)

In some embodiments, one or more users 230 may request or initiate a transaction with one or more of members 220-223. For example, user(s) 230 may request a loan to be financed/refinanced/modified, submit a loan payment, request an ownership change, check a loan balance or outstanding principal, request any other suitable service, or any suitable combination thereof.

In some embodiments, one or more providers 240 may provide information associated with a transaction by one or more of members 220-223. In some embodiments, protocol entity 202 may request information from provider(s) 240 in connection with one or more transactions associated with one or more of members 220-223.

In an illustrative example, a user of user(s) 230 may initiate a request to refinance a mortgage loan with member 222. Accordingly, the user may submit an application to member 222 including refinance information. Member 222 may transmit a refinance packet to protocol entity 202, including at least some refinance information. Protocol entity 202 may, in response to receiving the refinance packet, request compliance information from a provider of provider(s) 240. Protocol entity 202 may, in response to receiving the refinance packet, generate one or more smart contracts to confirm and update ownership, transfer value tokens, and store compliance information.

In some embodiments, one or more network entities (e.g., a node, member, or protocol entity) may be implemented using a multitenancy arrangement. For example, two nodes may be associated with a particular computing equipment and node application, but may process data in a partitioned, and separate, manner. In some embodiments, one or more network entities (e.g., a node, member, or protocol entity) may be implemented using one or more virtual machines. For example, a node and a member may be network entities implemented using the same computing equipment, each using separate applications implemented with respective virtual machines implemented by the computing equipment.

In some embodiments, the protocol entity is configured to add a member to the network. For example, an applicant that wishes to originate a loan on the blockchain system may be vetted by the protocol entity (e.g., in accordance with guidelines set by its governance and known to the nodes). The vetting process may include, for example, evaluation of licenses, promissory notes, and other documents, similar to a typical on-boarding process for a warehouse or forward flow agreement. Such vetting may continue over time. Upon successful vetting, the applicant becomes a member, for which the protocol entity approves a set of transactions available to the member. The set of transactions may include, for example, originating a loan, selling a loan, financing a loan, transacting value tokens, any other suitable transaction, or any suitable combination thereof. The protocol entity generates smart contracts to be hosted by each node and used to evaluate these transactions. The protocol entity may generate smart contracts for a member, for performing various tasks associated with their business that may be, but need not be (e.g., private conversations), part of the immutable record on the blockchain. In some embodiments, the member sets up an account (e.g., if it does not have one already) at one of the bank(s) that are integrated into the blockchain system. The bank may include a bank omnibus (e.g., a collection of many different banks), or an omnibus bank (e.g., a single banking entity).

In some embodiments, the protocol entity is configured to buy, sell, exchange, or otherwise transact value tokens among members. In some circumstances, a member may purchase/sell value tokens to emulate a fiat transaction (e.g., that might not be recorded in the blockchain), with an intent to sell/purchase the value tokens back. For example, the value tokens may serve as an intermediary for a transaction. Some transactions, for example, do not require the buying and selling of value tokens from other members. For example, a member may be funding a loan, and might move cash to an escrow account in an omnibus bank, which delivers to the member value tokens in consideration for the cash. The member then may sell the value tokens back to the omnibus bank, which then releases the cash to fund the loan. The blockchain system is configured to, for example, capture the second part of the transaction as part of a loan file (e.g., to verify funding). In some such circumstances, the price of the value tokens is irrelevant because the transaction of buying then selling the value tokens is instantaneous or nearly instantaneous (e.g., there is no value token exposure).

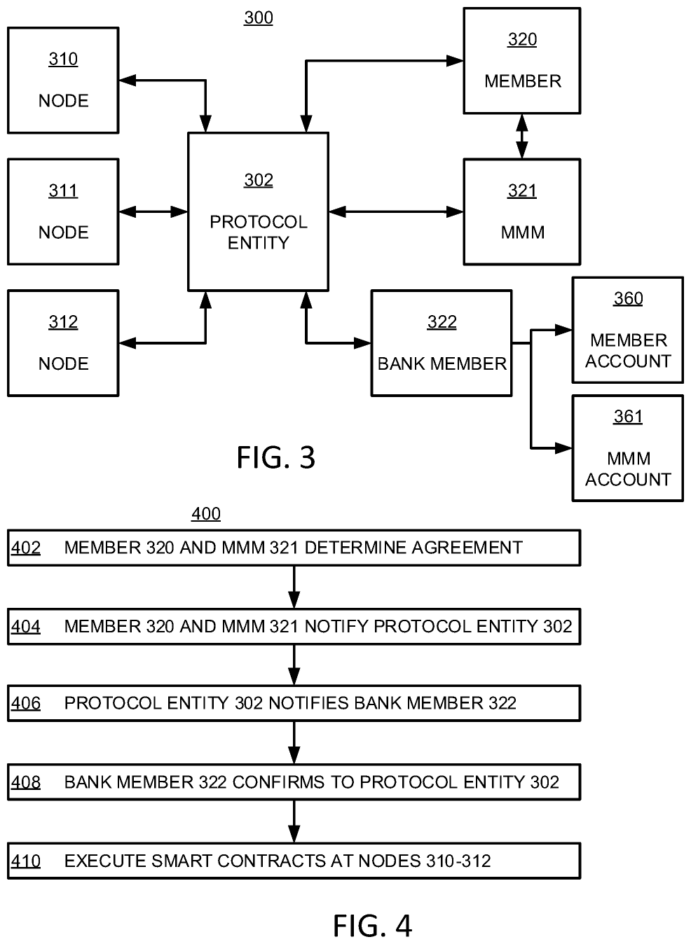

FIG. 3 shows a block diagram of illustrative blockchain system 300 for buying and selling value tokens, in accordance with some embodiments of the present disclosure. System 300 includes nodes 310, 311, and 312, protocol entity 302, member 320, market maker member 321, and bank member 322. Member 320 has associated account 360 and market maker member 321 has associated account 361, both with bank member 322. System 300 of FIG. 3 represents an illustrative example of system 200 of FIG. 2. FIG. 4 shows a flowchart of illustrative process 400 for buying and selling value tokens, in accordance with some embodiments of the present disclosure. For example, system 300 of FIG. 3 is configured to implement process 400 of FIG. 4.

Step 402 includes member 320 and market maker member 321 determining an agreement (e.g., agreeing to terms of an agreement). In some circumstances, the agreement may take place in the form of a private conversation. For example, the agreement may be a private conversation between member 320 and market maker member 321. In an illustrative example, member 320 may conduct a private conversation with market maker member 321 to agree to purchase a quantity of value tokens for a given amount (e.g., of fiat). Market maker member 321 may set the price of value tokens, for example. Member 320 may wish to purchase value tokens, sell value tokens, or otherwise make an exchange including value tokens.

Step 404 includes member 320 and market maker member 321 notifying protocol entity 302 of the agreement of step 402. Accordingly, protocol entity 302 is configured to receive agreement information from members (e.g., member 320, market maker member 321). Protocol entity 302 is configured to generate one or more smart contracts based on the agreement. The smart contracts may define a transaction and include, for example, a number of value tokens to transfer, a recipient account, a funding account, one or more identifiers, commands to direct bank member 322 to transfer funds between accounts (e.g., accounts 360 and 361), any other suitable information or commands, or any suitable combination thereof

Step 406 includes protocol entity 302 notifying bank member 322 of the proposed transaction. In some embodiments, protocol entity 302 may define a communications protocol for communicating to bank member 322. Protocol entity 302 may notify bank member 322 of an amount of value to transfer between account 360 of member 320 and account 361 of market maker member 321. Accordingly, bank member 322 may be configured to receive the notification and, in response, perform the funds transfer (i.e., the transaction).

Step 408 includes bank member 322 confirming the transaction to protocol entity 302. Bank member 322 may provide a notification to protocol entity 302 once the funds have been transferred. The notification may include, for example, a confirmation that funds were transferred.

Step 410 includes nodes 310-312 executing one or more smart contracts generated by protocol entity 302. Nodes 310-312 may host the one or more smart contracts. Execution of the smart contracts may create an immutable record of the transaction. For example, nodes 310-312 may execute the one or more smart contracts in an isolated computing environment, such as an isolated execution environment (e.g., a trusted execution environment (TEE)), and record the transaction as an encrypted entry in the record (e.g., as part of a block of the blockchain). In some embodiments, all necessary transaction data to satisfy any relevant compliance requirements, regulatory requirements, or both for a transaction may be stored on the blockchain. In some em2bodiments, all data forming a transaction may be stored on the blockchain. This capability is facilitated at least in part by the security provided by having all data be encrypted and corresponding cleartext being accessible only from within an isolated computing environment as further discussed below. In some embodiments, data that is not critical to a transaction or that is not required for compliance or regulatory purposes, such as certain validation data, may be stored off chain. Pointers to such data may be stored on the blockchain system.

In an illustrative example of process 400, member 320 may purchase value tokens to mimic a fiat transaction (e.g., not part of the blockchain), with the intent to immediately sell back value tokens. In some circumstances, such transactions do not require market maker member 321. For example, member 320 may be funding a loan, and might buy value tokens from bank member 322 (e.g., an omnibus bank or one of a bank omnibus), and immediately sell those value tokens back to bank member 322 with instructions to use the proceeds to fund the loan (e.g., the value tokens are used to transfer value). An omnibus bank includes a singular banking entity that may include a collective of banks, a plurality of banks, or otherwise a group of one or more banks. A bank omnibus is a set of banks (e.g., a plurality of banks), from which one or more may be selected for a transaction. Protocol entity 302 manages the second part of the transaction (e.g., as part of a loan file), verifying funding and causing the immutable record to be updated. In some such circumstances, the price of value tokens is irrelevant because there is no value token exposure (e.g., the transaction occurs in real time), and accordingly there may be no need for market maker member 321.

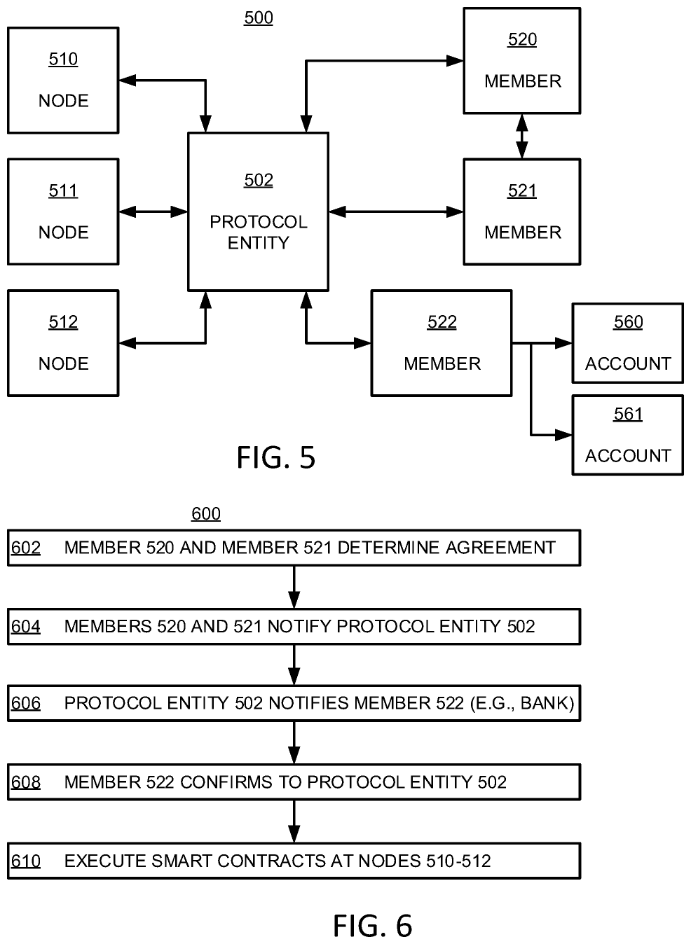

FIG. 5 shows a block diagram of illustrative blockchain system 500 for buying and selling value tokens, in accordance with some embodiments of the present disclosure. System 500 includes nodes 510, 511, and 512, protocol entity 502, and members 520, 521, and 522. Member 520 has associated account 560 and member 521 has associated account 561, both via member 522 (e.g., an omnibus bank, or one of a bank omnibus). System 500 represents and illustrative example of system 200. FIG. 6 shows a flowchart of illustrative process 600 for buying and selling value tokens, in accordance with some embodiments of the present disclosure. For example, system 500 of FIG. 5 is configured to implement process 600 of FIG. 6. In a further example, process 600 of FIG. 6 may be similar to process 400 of FIG. 4.

Step 602 includes member 520 and member 521 determining an agreement (e.g., agreeing to terms of an agreement). In some circumstances, the agreement may take place in the form of a private conversation. For example, the agreement may be a private conversation between members 520 and 521. In an illustrative example, member 520 may conduct a private conversation with member 521 to agree to sell a quantity of value tokens for a given amount (e.g., of fiat).

Step 604 includes member 520 and member 521 notifying protocol entity 502 of the agreement of step 602. Accordingly, protocol entity 502 is configured to receive agreement information from members. Protocol entity 502 is configured to generate one or more smart contracts based on the agreement of step 602. The smart contracts may define a transaction and include, for example, a number of value tokens to transfer, a recipient account, a funding account, one or more identifiers, commands to direct member 522 to transfer funds between accounts (e.g., accounts 560 and 561), any other suitable information or commands, or any suitable combination thereof.

Step 606 includes protocol entity 502 notifying member 522 of the proposed transaction. In some embodiment, protocol entity 502 may await confirmation from member 522.

Step 608 includes member 522 confirming the transaction to protocol entity 502. For example, member 522 may confirm a transfer of value between account 560 and account 561.

Step 610 includes nodes 510-512 executing one or more smart contracts generated by protocol entity 502. Nodes 510-512 may host the one or more smart contracts. Execution of the smart contracts may create an immutable record of the transaction. For example, nodes 510-512 may execute the one or more smart contracts in an isolated computing environment and record the transaction as an encrypted entry in the record (e.g., as part of a block of the blockchain).

It will be understood that the blockchain system of the present disclosure may be used as a platform to implement any suitable transaction in any suitable context. For purposes of brevity and clarity, however, and not by way of limitation, the discussion which follows is presented in the context of implementing a loan system by which loans may be originated, financed, updated, securitized, and traded using the blockchain system in accordance with the present disclosure.

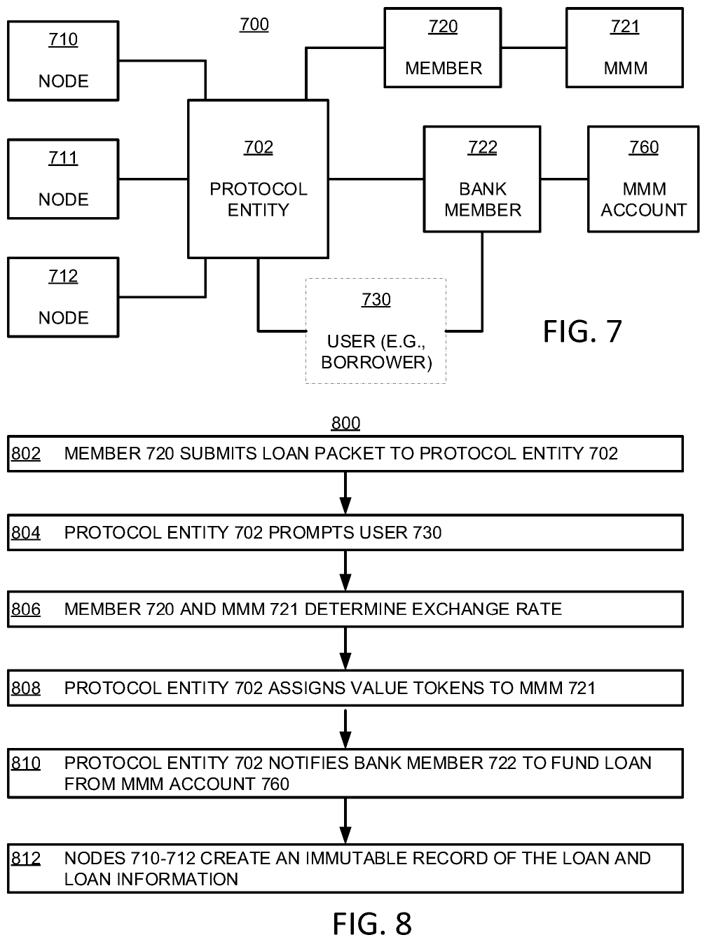

FIG. 7 shows a block diagram of illustrative blockchain system 700 for originating a loan, in accordance with some embodiments of the present disclosure.

System 700 includes nodes 710, 711, and 712, protocol entity 702, member 720, market maker member 721, and bank member 722. User 730 may interact with system 700 (e.g., to sign documents, provide information, provide funds). Market maker member 721 has associated account 760 via bank member 722 (e.g., an omnibus bank, or one of a bank omnibus). System 700 represents and illustrative example of system 200 of FIG. 2. FIG. 8 shows a flowchart of illustrative process 800 for originating a loan, in accordance with some embodiments of the present disclosure. For example, system 700 of FIG. 7 is configured to implement process 800 of FIG. 8.

Step 802 includes member 720 submitting a loan packet to protocol entity 702. The loan packet may include a credit report, a credit score, a title, an automated valuation model (AVM), any other suitable documentation, or any suitable combination thereof. In some embodiments, one or more documents of the loan packet may include a digital signature (e.g., to eliminate a requirement for member trust).

Step 804 includes protocol entity 702 prompting user 730. In some embodiments, for example, protocol entity 702 may prompt user 730 to sign promissory note on behalf of member 720, deliver disclosures (e.g., Truth in Lending Act disclosures, closing disclosures, or other disclosures), wait out a rescission period, perform any other suitable actions (e.g., that may be visible to nodes 710-712), or any suitable combination thereof

Step 806 includes member 720 and market maker member 721 determining an exchange rate. In some embodiments, member 720, market maker member 721, or both generate delivery instructions to user 730.

Step 808 includes protocol entity 702 assigning value tokens to market maker member 721 from member 720. In some embodiments, protocol entity 702 may determine whether account 760 has sufficient funds.

Step 810 includes protocol entity 702 notifying bank member 722 to fund the loan from account 760 associated with market maker member 721.

Step 812 includes nodes 710-712 creating an immutable record of the loan and loan information. In some embodiments, the immutable record may include, for example, whether/when underwriting was done correctly, whether the promissory note is signed, whether/when disclosures were sent, whether/when funds were dispersed, any other suitable information, or any suitable combination thereof. In some embodiments, the record of step 812 may be the first link of a chain of transactions specific to the loan.

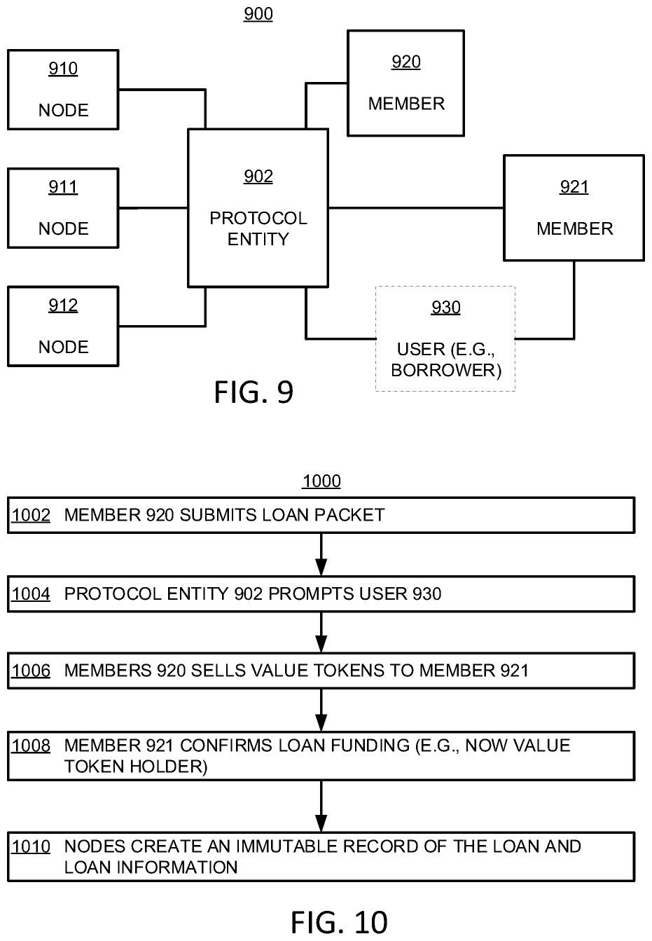

FIG. 9 shows a block diagram of illustrative system 900 for originating a loan, in accordance with some embodiments of the present disclosure. System 900 includes nodes 910, 911, and 912, protocol entity 902, and members 920 and 921. User 930 may interact with system 900 (e.g., to sign documents, provide information, provide funds). Member 921 may include a bank (e.g., an omnibus bank, or one of a bank omnibus), configured to accept, store, and release value tokens and fiat associated with transactions. System 900 represents and illustrative example of system 200 of FIG. 2. FIG. 10 shows a flowchart of illustrative process 1000 for originating a loan, in accordance with some embodiments of the present disclosure. For example, system 900 of FIG. 9 is configured to implement process 1000 of FIG. 10.

Step 1002 includes member 920 submitting a loan packet to protocol entity 902. The loan packet may include, for example, a credit report, a credit score, a title, an automated valuation model (AVM), any other suitable documentation, or any suitable combination thereof. In some embodiments, one or more documents of the loan packet may include a digital signature (e.g., to eliminate a requirement for member trust).

Step 1004 includes protocol entity 902 prompting user 930. In some embodiments, for example, protocol entity 902 may prompt user 930 to sign promissory note on behalf of member 920, deliver disclosures (e.g., Truth in Lending Act (TILA) disclosures, closing disclosures, or other disclosures), wait out a rescission period, perform any other suitable actions (e.g., that may be visible to nodes 910-912), or any suitable combination thereof

Step 1006 includes member 920 selling value tokens to member 921. In some embodiments, member 920 provides instructions to use at least some of the sold value tokens to fund the loan.

Step 1008 includes member 921 confirming funding of the loan, thus becoming owner of the value tokens.

Step 1010 includes nodes 910-912 creating an immutable record of the loan and loan information. In some embodiments, the immutable record may include, for example, whether/when underwriting was done correctly, whether the promissory note is signed, whether/when disclosures were sent, whether/when funds were dispersed, any other suitable information, or any suitable combination thereof. In some embodiments, the record of step 1010 may be the first link of a chain of transactions specific to the loan. For example, steps 1008 and 1010 may include member 921 acting as an escrow account for the transaction.

In an illustrative example, member 920 may gather loan information (e.g., a loan application) from user 930, and submit a loan packet to protocol entity 902 to originate a mortgage loan. Protocol entity 902 prompts user 930 for further information or interaction (e.g., compliance information, signatures) to process the transaction. Member 920 provides value tokens to member 921 and prompts member 921 to fund the loan. Member 921 provides funding for the loan to user 930 (e.g., as fiat). Accordingly, repayment may then occur from user 930 to member 920 as installments, for example.

In an illustrative example, a borrower may interact with an originator's loan origination system (LOS), with all information entered directly by the borrower. Loan underwriting is then performed using the LOS, with all origination and application details recorded in the LOS. When the originator determines that all closing conditions have been cleared, the originator then approves the loan for funding and requests to have the loan onboarded to the protocol entity. The protocol entity uses smart contracts to validate whether the conditions for funding have been satisfied and initiate the document execution and the closing process. The borrower uses an online notary to execute all loan documents (e.g., the notary process is recorded and stored in the loan file). In this example, the online notary provides an additional level of identity verification. Upon expiration of a rescission period, the originator may wire loan proceeds to the borrower's account. In this example, there is no need to use an escrow or closing agent. The deed/mortgage is then sent out for recording. The loan servicer has the full loan file and is able to start servicing the loan without any additional onboarding or delay. The loan packet (e.g., including all of the documents, data, disclosures and the results of the loan validation) are submitted and immutably recorded using the blockchain system. This helps reduce the risk of fraud at loan origination. For example, there is a clear record of whether a complete file exists and how the funds were disbursed. The loan data and documentation are validated by the blockchain system. Exceptions are noted and transparent to the originator and any future buyer or investor. Once the loan has been onboarded, the loan file contents cannot be changed. For example, the contents are immutable and could only be appended to with the consensus of all the nodes.

In an illustrative example, loan validation may include underwriting, document submission, compliance review, ownership verification, and servicing. Underwriting may include credit checks, digital signatures, credit policy values (e.g., value, mortgage, down payment, credit history, term, rate, income, loan-to-value-ratio, pricing, income-to-payment ratio), and anti-fraud verifications. Documents for submission may include an agreement (e.g., a HELOC agreement), loan statement, compliance agreement, disclosures, property description, right-to-cancel, deed, appraisal, credit counseling forms, identification documents, payment agreements, any other suitable documentation, or any combination thereof. Compliance review may include first lien compliance (e.g., loan APR is less than 8% or other cap), and/or other compliance review. Loan validation may include verifying that the originator is the owner of the loan. Servicing may include origination fees, interest accruals, fee assessments (e.g., late fees), payment-based fees, payments, disclosures, any other servicing documents, or any combination thereof.

In some embodiments, the protocol entity is configured to receive and manage a loan payment from a user. For example, the blockchain system may act as a ledger, applying payments to loan principal and identifying missing or late payments. In a further example, the blockchain system may provide proof of receipt for loan payments by updating the immutable database.

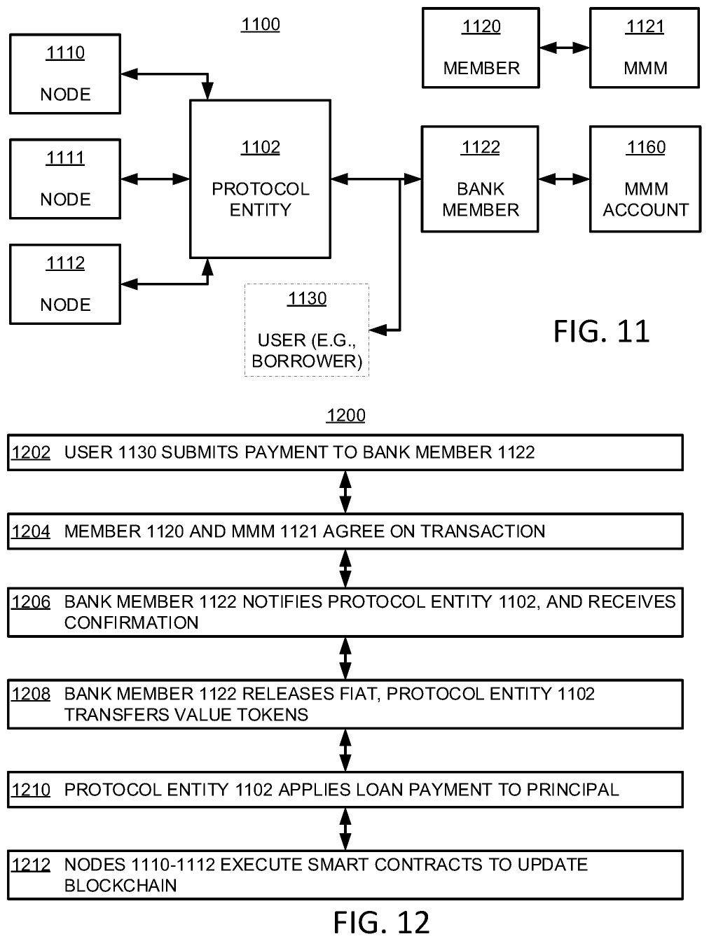

FIG. 11 shows a block diagram of illustrative system 1100 for managing a loan payment, in accordance with some embodiments of the present disclosure. System 1100 includes nodes 1110, 1111, and 1112, protocol entity 1102, and member 1120, market maker member 1121, and bank member 1122. User 1130 (e.g., a borrower making repayment) may interact with system 1100 (e.g., to provide payment funds). Member 1122 may include a bank (e.g., an omnibus bank, or one of a bank omnibus), configured to accept, store, and release value tokens and fiat associated with transactions. System 1100 represents and illustrative example of system 200 of FIG. 2. FIG. 12 shows a flowchart of illustrative process 1200 for managing a loan payment, in accordance with some embodiments of the present disclosure. For example, system 1100 of FIG. 11 is configured to implement process 1200 of FIG. 12.

Step 1202 includes user 1130 submitting a payment to bank member 1122. For example, user 1130 may have taken a loan having an associated repayment schedule (e.g., in monthly installments). In a further example, user 1130 may submit the payment using the Automated Clearing House (ACH) network.

Step 1204 includes member 1120 and market maker member 1121 agreeing on a transaction. For example, member 1120 and market maker member 1121 may agree on an exchange rate between value tokens and fiat. In a further example, member 1120 and market maker member 1121 may agree on a round-trip transaction including a sell/buy and subsequent buyback/sellback (e.g., having little to no exposure in value tokens).

Step 1206 includes bank member 1122 notifying protocol entity 1102 of the receipt of payment and receiving confirmation from protocol entity 1102 to release the payment to market maker member 1121. Protocol entity 1102 is configured to determine that the payment is correct and timely, for example, in response to the notification.

Step 1208 includes bank member 1122 releasing fiat to account 1160 associated with market maker member 1121, and protocol entity 1102 transferring value tokens from market maker member 1121 to member 1120. The releasing of fiat, and the transfer of value tokens may occur in any suitable order, or simultaneously.

Step 1210 includes protocol entity 1102 applying the loan payment to the loan principal. In some embodiments, protocol entity 1102 generates a smart contract that includes information indicative of the loan payment (e.g., the payment amount applied to the principal, the remaining principal balance, or other information).

Step 1212 includes nodes 1110-1112 creating an immutable record of the loan payment (e.g., the transfer of value tokens from market maker member 1121 to member 1120). In some embodiments, the record of step 1212 may be the newest link of a chain of transactions specific to the loan.

In an illustrative example, protocol entity 1102 can generate smart contracts to be executed by nodes 1110-1112 that record on the blockchain payment history, late payments, missing payments, partial payments, any other suitable payment information, or any suitable combination thereof.

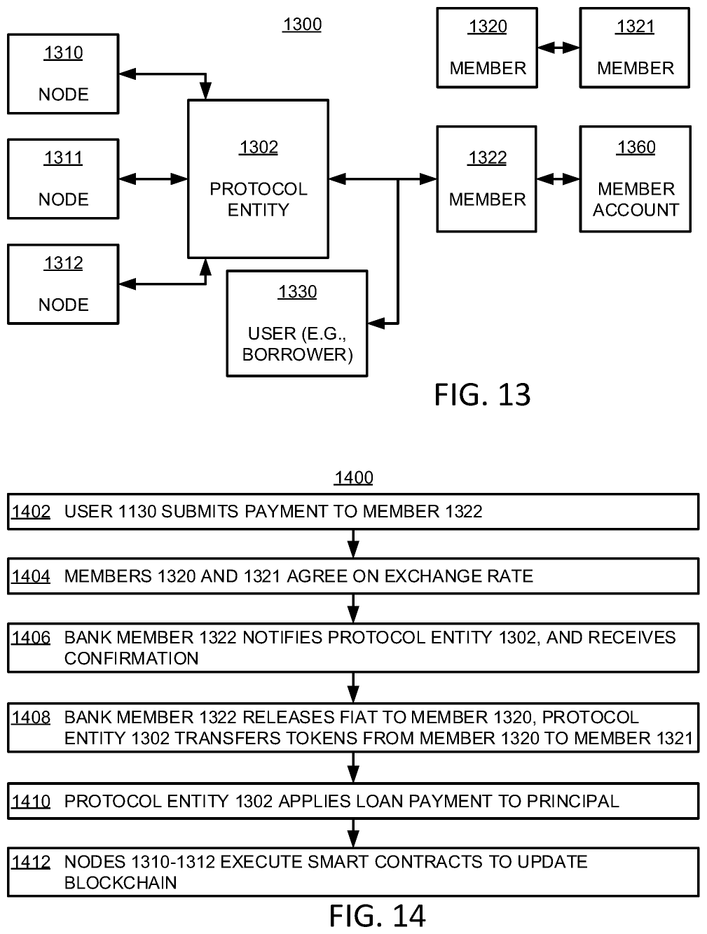

FIG. 13 shows a block diagram of illustrative system 1300 for managing a loan payment, in accordance with some embodiments of the present disclosure. System 1300 includes nodes 1310, 1311, and 1312, protocol entity 1302, and members 1320, 1321, and 1322. User 1330 (e.g., a borrower making repayment) may interact with system 1300 (e.g., to provide payment funds). Member 1322 may include a bank (e.g., an omnibus bank, or one of a bank omnibus), configured to accept, store, and release value tokens and fiat associated with transactions. System 1300 represents and illustrative example of system 200 of FIG. 2. FIG. 14 shows a flowchart of illustrative process 1400 for managing a loan payment, in accordance with some embodiments of the present disclosure. For example, system 1300 of FIG. 13 is configured to implement process 1400 of FIG. 14.

Step 1402 includes user 1330 submitting payment to member 1322. For example, user 1130 may have taken a loan having an associated repayment schedule (e.g., in monthly installments). In a further example, user 1330 may submit the payment using the Automated Clearing House (ACH) network.

Step 1404 includes members 1320 and 1321 agreeing on a transaction.

For example, member 1320 and member 1321 may agree on an exchange rate between value tokens and fiat. In a further example, member 1320 and member 1321 may agree on a round-trip transaction including a sell/buy and subsequent buyback/sellback (e.g., having little to no exposure in value tokens).

Step 1406 includes member 1422 notifying protocol entity 1402 of the receipt of payment from user 1330 and receiving confirmation from protocol entity 1302 to release the payment to member 1120. Protocol entity 1302 is configured to determine that the payment is correct and timely, for example, in response to the notification.

Step 1408 includes member 1322 releasing fiat to account 1360 associated with member 1320, and protocol entity 1302 transferring value tokens from member 1320 to member 1321. The releasing of fiat, and the transfer of value tokens may occur in any suitable order, or simultaneously.

Step 1410 includes protocol entity 1302 applying the loan payment to the loan principal. In some embodiments, protocol entity 1302 generates a smart contract that includes information indicative of the loan payment (e.g., the payment amount applied to the principal, the remaining principal balance, or other information).

Step 1412 includes nodes 1310-1312 creating an immutable record of the loan payment (e.g., the transfer of value tokens from member 1320 to member 1321). In some embodiments, the record of step 1412 may be the newest link of a chain of transactions specific to the loan.

In an illustrative example, a loan servicer initiates payment from a borrower's bank. The servicer's payment processor then notifies the protocol entity of receipt of payment, and the confirmation of receipt is recorded on the blockchain system. The blockchain system applies the loan payment to the outstanding loan balance. Nodes confirm a token receipt for payment, and a new link is subsequently added to the loan chain. The protocol entity store information regarding when a loan should receive payment and can record late, missing or partial payments. In this example, the blockchain system becomes the sub-servicer of the loan, with the master servicer controlling statements, outreach and pulling non-performing loans off of the blockchain system for special servicing.

In some embodiments, the protocol entity may be configured to implement a loan platform for buying, selling, or otherwise exchanging existing loans.

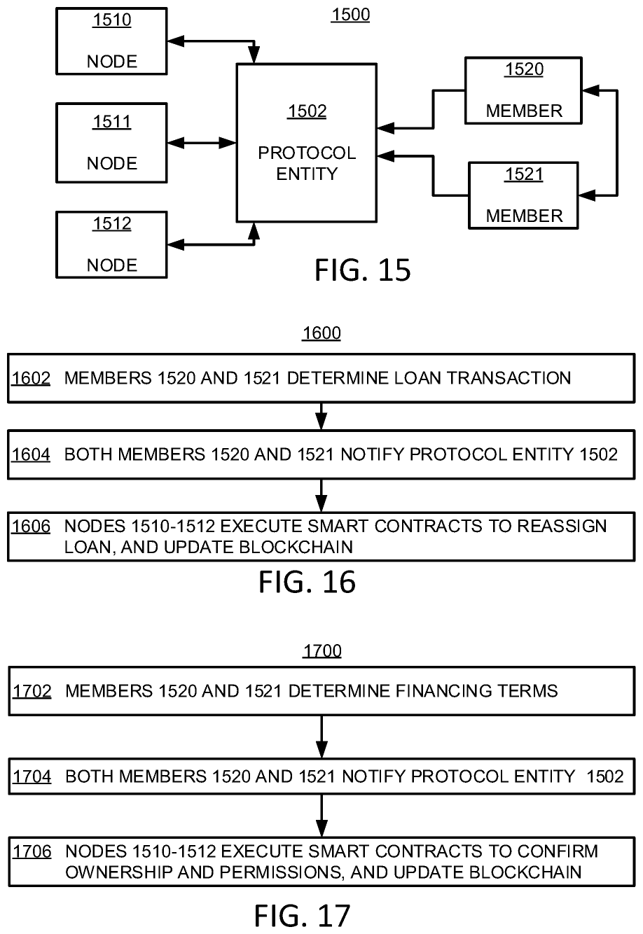

FIG. 15 shows a block diagram of illustrative system 1500 for managing loans, in accordance with some embodiments of the present disclosure. System 1500 includes nodes 1510, 1511, and 1512, protocol entity 1502, and members 1520 and 1521. System 1500 represents and illustrative example of system 200 of FIG. 2. FIG. 16 shows a flowchart of illustrative process 1600 for buying or selling a loan, in accordance with some embodiments of the present disclosure. For example, system 1500 of FIG. 15 is configured to implement process 1600 of FIG. 16.

Step 1602 includes members 1520 and 1521 determining a loan transaction between them. For example, the loan transaction may include selling a loan, or interest in a loan thereof. Members 1520 and 1521 may determine the loan transaction between themselves (e.g., a private conversation), not as part of the blockchain record. For example, members 1520 and 1521 may agree to sell/buy a loan for a particular number of value tokens.

Step 1604 includes members 1520 and 1521 notifying protocol entity 1502 of the proposed transaction (e.g., their intent). In some embodiments, protocol entity 1502 receives the notifications separately. For example, protocol entity 1502 may wait to receive both notifications before generating a smart contract.

Step 1606 includes nodes 1510, 1511, and 1512 executing one or more smart contracts to reassign a loan and update the blockchain. In some embodiments, the one or more smart contracts confirm ownership of the loan, value tokens, and associated permissions. In some embodiments, the one or more smart contracts reassign the loan and value token at, or near, the same time (e.g., simultaneously). In some embodiments, the one or more smart contracts add a block to the blockchain (e.g., a link to the loan chain). Protocol entity 1502 generates the one or more smart contracts based on the notification of step 1604, and nodes 1510-1512 receive and host the one or more generated smart contracts.

In some embodiments, the protocol entity is configured to finance loans to users. FIG. 17 shows a flowchart of an illustrative process for financing a loan, in accordance with some embodiments of the present disclosure. For example, system 1500 of FIG. 15 may be configured to perform process 1700 of FIG. 17. Members may finance assets through warehouse agreements with other members, using the blockchain system. For example, members may have smart contracts generated by protocol entity 1502 to manage where assets are pledged to optimize return on equity (ROE), improve liquidity (e.g., of interest to the loan originator), manage concentration and other limits (e.g., of interest to a lender), perform any other asset management function, or any suitable combination thereof. In a further example, system 1500 may serve as a registry of loan pledging.

Step 1702 includes members 1520 and 1521 determining financing terms. In some circumstances, members 1520 and 1521 may determine the financing terms between themselves (e.g., a private conversation), not as part of the blockchain record. For example, members 1520 and 1521 may determine an advance rate, a funding rate, a warehouse agreement, any other financing agreement or term thereof, or any suitable combination thereof. To illustrate, member 1520 may propose to finance a loan with member 1521.

Step 1704 includes members 1520 and 1521 notifying protocol entity 1502 of the proposed terms (e.g., their intent). In some embodiments, protocol entity 1502 receives the notifications separately. For example, protocol entity 1502 may wait to receive both notifications before generating a smart contract.

Step 1706 includes nodes 1510, 1511, and 1512 executing one or more smart contracts to pledge the loan and update the blockchain. In some embodiments, the one or more smart contracts confirm ownership of the loan, value tokens, and associated permissions. In some embodiments, the one or more smart contracts pledge the loan and transfer the value token(s) at, or near, the same time (e.g., simultaneously). In some embodiments, the one or more smart contracts add a block to the blockchain (e.g., a link to the loan chain). Protocol entity 1502 generates the one or more smart contracts based on the notification of step 1604, and nodes 1510-1512 receive and host the one or more generated smart contracts.

To illustrate, member 1520 may have unilateral authority to claim the loan, which may be included as part of the one or more smart contracts executed by nodes 1510-1512. Claim can come from a breach outside the blockchain (e.g., net worth, or other fiat), or from asset performance records included as part of the blockchain (e.g., and retrievable from the blockchain). For example, the one or more smart contracts may automatically, or manually, adjust advance rates, interest, or other parameters subject to asset performance, any other suitable criteria, or any suitable combination thereof.

In an illustrative example, a buyer may define eligibility criteria for loan(s) that an originator can offer to the buyer using the blockchain system. When the originator proposes loan sales to the buyer, the buyer may review each loan, including loan status, underwriting, and loan documents. The Buyer confirms an intent to purchase the loan(s) at agreed upon terms (e.g., price, settlement date, cut-off date, servicing). Accrued interest and servicing may be automatically updated to reflect all activity as of the close of business the day prior to the trade date. Accordingly, there is no need to manually reconcile servicing. The Buyer sends payment to the originator using the blockchain system, and the loan ownership is updated using the blockchain system to reflect the buyer as the owner as soon as the payment is received. In this example, assignments are recorded at the county for each loan. The buyer can observe all loans in inventory and observe performance daily (e.g., as opposed to a monthly basis).

In an illustrative example, an originator may instruct the protocol entity to send loans to a warehouse lender. The protocol entity automatically allocates loans to the warehouse lender based on, for example, eligibility criteria predetermined by the warehouse lender that are coded into smart contracts. The smart contracts are configured to determine when closing conditions have been met and send funding requests to the warehouse lender using the blockchain system. Funding requests may include relevant terms (e.g., advance rate, sub-limits), which are set by the smart contracts. When the warehouse lender approves funding requests, the funds are transferred to the originator. The blockchain system simultaneously updates the distributed ledger to reflect that the loans have been pledged to the warehouse lender. The blockchain system automatically directs servicing remittances to the warehouse lender and applies them to amount due to the warehouse lender. In this example, there is no need for the servicer to reconcile monthly remittances, because servicing remittances can be handled on a daily basis. The protocol entity, continually monitors loans for pricing, sub-limits and performance.

In some embodiments, the protocol entity is configured to securitize loans on the network.

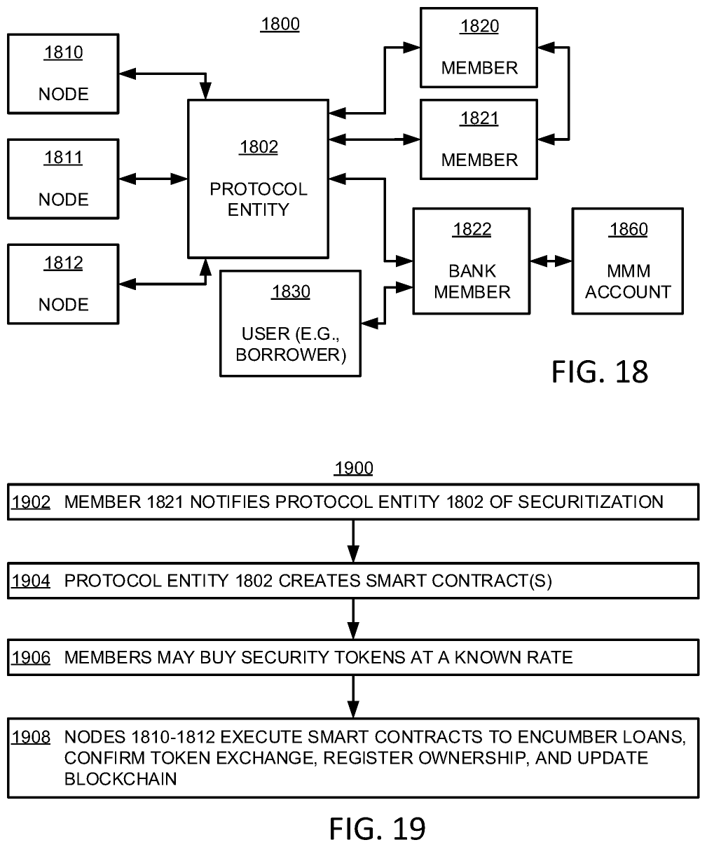

FIG. 18 shows a block diagram of illustrative system 1800 for securitizing a loan, in accordance with some embodiments of the present disclosure. System 1800 includes nodes 1810, 1811, and 1812, protocol entity 1802, members 1820 and 1821, and bank member 1822. User 1830 may interact with system 1800. Account 1860 is associated with a market maker member. System 1800 represents and illustrative example of system 200 of FIG. 2. FIG. 19 shows a flowchart of illustrative process 1900 for securitizing a loan, in accordance with some embodiments of the present disclosure. For example, system 1800 of FIG. 18 is configured to implement process 1900 of FIG. 19.

Step 1902 includes member 1821 notifying protocol entity 1802 of securitization. For example, member 1821 may notify protocol entity 1802 to which loans support securitization, types of security tokens, aspects of payment scheduling (e.g., a cash flow waterfall), any other suitable information regarding securitization, or any suitable combination thereof

Step 1904 includes protocol entity 1802 creating one or more smart contracts. In some embodiments, the one or more smart contracts are configured to distribute cash flows to security tokens. In some embodiments, the one or more smart contracts include features such as accelerated prepayment or other suitable adjustments (e.g., that may be tied to collateral performance).

Step 1906 includes members buying security tokens at a known rate. In some embodiments, members may buy security tokens with value tokens, having a known, or agreed upon, exchange rate. For example, the market maker member may determine the exchange rate between value tokens and security tokens.

Step 1908 includes nodes 1810-1812 executing one or more smart contracts to encumber loans, confirm token exchange, register ownership, and update the blockchain. Protocol entity 1802 generates the one or more smart contracts based on the notification of step 1902, and nodes 1810-1812 receive and host the one or more generated smart contracts.

In an illustrative example, the security tokens may have an associated code based on the Committee of Uniform Security Identification Procedures (CUSIP) system. In a further example, the security tokens may have an associated rating (e.g., indicating credit worthiness).

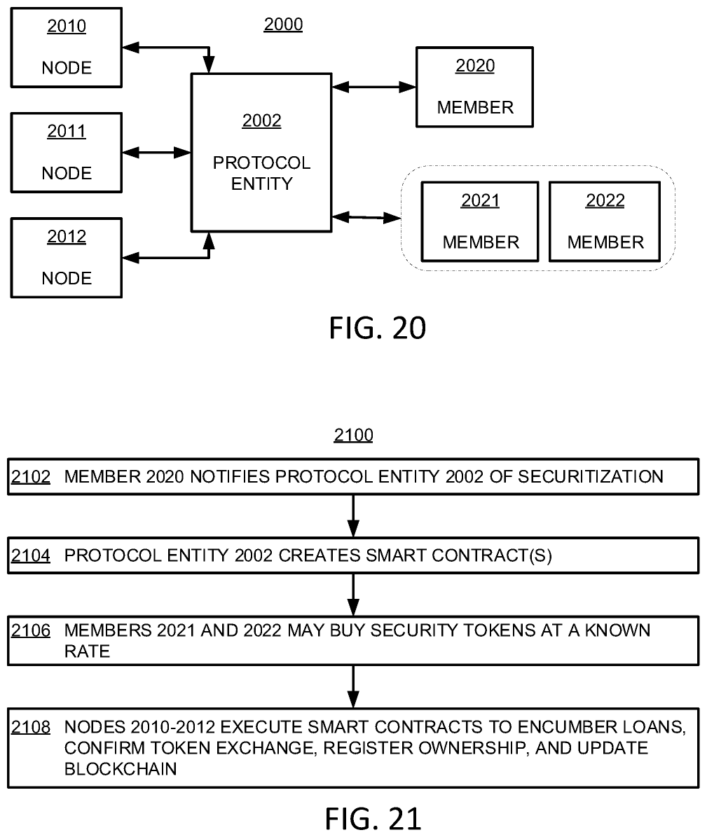

FIG. 20 shows a block diagram of illustrative system 2000 for securitizing a loan, in accordance with some embodiments of the present disclosure. System 2000 includes nodes 2010, 2011, and 2012, protocol entity 2002, members 2020, 2021, and 2022. System 2000 represents and illustrative example of system 200 of FIG. 2. FIG. 21 shows a flowchart of illustrative process 2100 for securitizing a loan, in accordance with some embodiments of the present disclosure. For example, system 2000 of FIG. 20 is configured to implement process 2100 of FIG. 21.

Step 2102 includes member 2020 notifying protocol entity 2002 of securitization.

Step 2104 includes protocol entity 2002 creating one or more smart contracts. In some embodiments, the one or more smart contracts are configured to distribute cash flows to owners of security tokens. In some embodiments, the one or more smart contracts include features such as accelerated payment or other suitable adjustments (e.g., that may be tied to collateral performance).

Step 2106 includes members (e.g., members 2021 and 2022) buying security tokens at a known rate. In some embodiments, members may buy security tokens with value tokens, having a known, or agreed upon, exchange rate.

Step 2108 includes nodes 2010-2012 executing one or more smart contracts to encumber loans, confirm token exchange, register ownership, and update the blockchain. Protocol entity 2002 generates the one or more smart contracts based on the notification of step 2102, and nodes 2010-2012 receive and host the one or more generated smart contracts.

In some embodiments, a security including one or more loans is administered by protocol entity 2002. Accordingly, loan payments may be managed, and dividends paid to security token holders in real-time. Because protocol entity 2002 may generate smart contracts to update the immutable record of payments, and also may generate smart contracts to distribute dividends, the process may occur in, or near to, real-time. For example, a pool of securities may be held in whole or in part, such that token ownership may be fractional and/or represent tranches of the securitization.

In an illustrative example, an originator pools assets and allocates eligible loans for securitization using smart contracts generated by the protocol entity. An underwriter structures the securitization. An underwriter sells the ABS to investors. Payments are made and recorded using the blockchain system and payments to investors are automated (e.g., waterfall rules may be coded into smart contracts) and disbursed to investors as soon as they are paid and settled through the blockchain system.

In some embodiments, regarding storage of data on a blockchain by the blockchain system, hashing is used in the construction. When a loan is first onboarded, the entire loan file is hashed with strong encryption methods to secure the data. Every time there is a new transaction (e.g., owner change or payment or delinquency status), the existing hash is combined with a new hash from the additional data. The hash helps create the immutable aspect of the history of the loan. Each new “transaction” or block is confirmed by the nodes. Using smart contracts, the nodes confirm that the transactions are valid and do not conflict with the previous blocks linked (e.g., the immutable record). In some embodiments, value tokens must be used to transact on the blockchain system. Value tokens are necessary, for example, because of the lack of transparency into bank accounts. To illustrate, it is difficult or impossible for multiple parties to truly confirm the cash movement of thousands of transactions occurring between different banks and parties (e.g., borrowers, servicers, insurance providers, sellers, warehouse lenders). The blockchain system uses value tokens to remove the need to rely on third parties and to provide full transparency for every transaction related to a loan. When a value token is used to transact on the blockchain system, cash is assigned a value token representation to add the transaction to the ledger. To illustrate, if a buyer purchases a loan, the cash used for the purchase will be assigned a value of value tokens and the transfer of value tokens between the buyer and the seller (e.g., representing the concurrent fiat exchange) will be memorialized on the blockchain (e.g., the immutable record). Using value tokens for a transaction does not expose the parties to value token price volatility, because the cash is converted to value tokens and instantaneously converted back to cash. The value token exchange record function as an accounting or an auditing trail.

In an illustrative example, regarding borrower payments, every payment made by a borrower has a cash to value token conversion. The conversion of the cash to value tokens and back is instantaneous and value tokens are recorded on the ledger. Every permissioned party can observe the timestamp and the application of the loan proceeds to the loan. Parties need not trust the servicer since there is transparency to the asset and all transactions related to the asset have been recorded on the distributed ledger.

In an illustrative example, regarding loan purchases, a buyer sends cash to a bank omnibus account. The receipt of the cash is memorialized by an instantaneous conversion to value tokens and back to cash. Each loan that is purchased in that transaction is allocated value tokens and now has a record of the transaction to show the receipt of value tokens and the transfer of ownership. The transaction information is only visible to the transacting parties and is immutable.

Hosts of the protocol entity run a node that stores distributed smart contracts and encrypted data. Having multiple network entities hosting nodes allows the blockchain system to maintain a trustless environment, where nodes must have consensus to write data to the distributed ledger (e.g., updating the blockchain), which may help in eliminating malfeasance within the blockchain system. In some embodiments, nodes are hosted within a cloud data center. Nodes are configured to execute smart contracts against encrypted data to converge on a known good state of data. The nodes are responsible for maintaining the integrity of their copy of all data, as well as processing any changes in the provenance of an asset.

The blockchain system, as implemented by the nodes, is distributed, immutable, and trustless. For example, each host maintains a secure computing environment in which network services are performed. In some embodiments, security is inherent in the design of the blockchain system. For example, each node may be secured with industry standard elliptic-curve encryption for data in transit, data at rest, or both. In a further example, nodes may be maintained using the Principle of Least Privilege (PoLP) to provide access, for which each entity access to information that are deemed necessary. In a further example, network firewalls may be configured to allow only communication with other nodes, and each node has a limited set of allowed services pertaining to the blockchain system. In an illustrative example, nodes may be implemented within one or more a cloud-based network. Cloud-based computing may help simplify node creation and may result in a reduced time investment for hosts as well as the protocol entity.

In some embodiments, the blockchain system performs routine audits of smart contracts to guarantee code integrity. For example, each smart contract may be maintained using a strict change-management policy that guarantees each smart contract that is released to the network of nodes has been thoroughly vetted for accuracy and confirms the absence of malfeasance. In some embodiments, containers configured to implement isolated computing environments are updated, maintained current, or otherwise managed by one or more applications of the protocol entity.

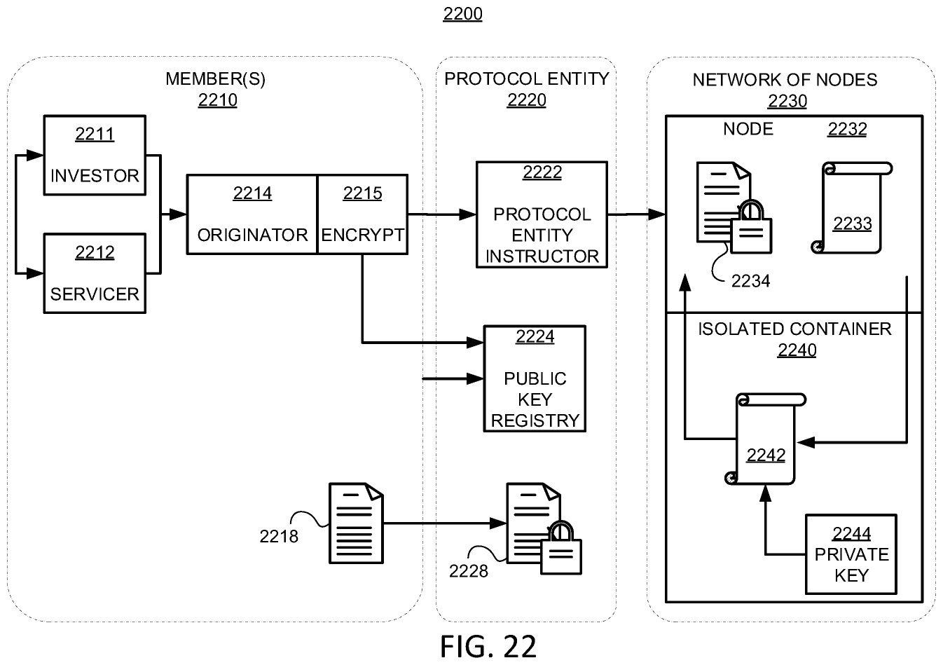

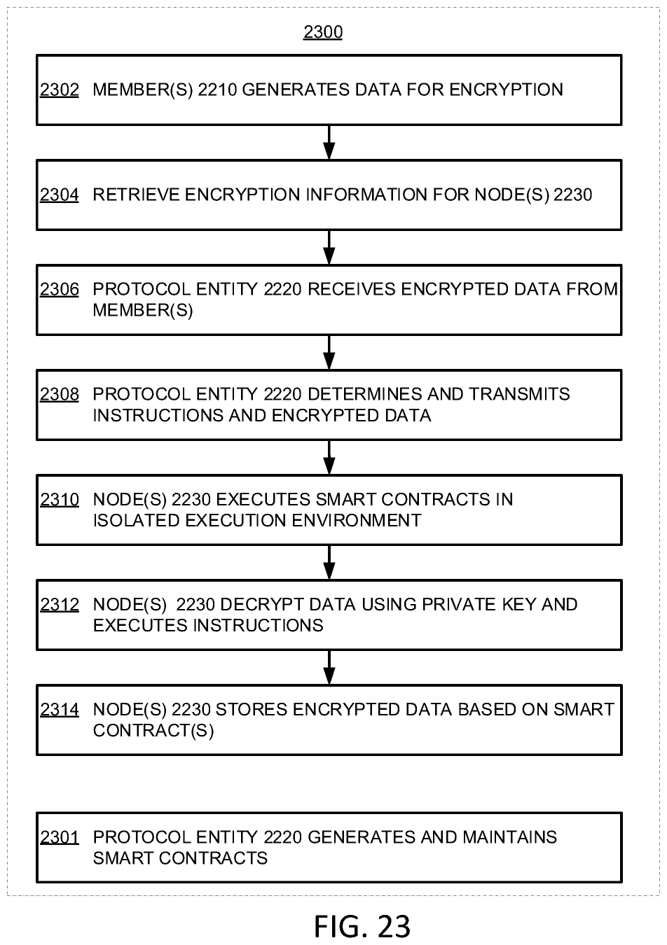

FIG. 22 shows a block diagram of an illustrative system 2200 for managing a transaction in accordance with some embodiments of the present disclosure. In some embodiments, protocol entity 2220 is hosted on dedicated computing equipment, managed by a non-member entity. In some embodiments, the protocol entity is used as a registry, ledger and exchange. For example, the exchange may include a transaction ledger that is on chain. A marketplace may include a layer around the protocol entity. For example, the marketplace may include one or more API's and provide a way for members to interact and communicate with the protocol entity. System 2200 includes members 2210, protocol entity 2220, and nodes 2230, coupled by a suitable network. FIG. 23 shows a flowchart of illustrative process 2300 for managing a transaction of a blockchain system, in accordance with some embodiments of the present disclosure. System 2200 may be used to implement illustrative process 2300, which is described below in the context of system 2200. System 2200 of FIG. 22 is an illustrative example of system 100 of FIG. 1 and system 200 of FIG. 2.

Step 2302 includes member(s) 2210 generating data for encryption. In the illustrated example shown in FIG. 22, the data is in the context of an originator, servicer, and a potential loan buyer. Originator 2214 sends a public key associated with potential loan buyers (i.e., investor 2211) as well as servicer 2212 for the originated asset to public key registry 2224. Originator 2214 generates cleartext data 2218 to be encrypted (i.e., encrypted by application 2215 to encrypted data 2228) and sends encrypted data 2228 along with public keys (e.g., that are privileged) to decrypt encrypted data 2228. In some embodiments, additional public keys are provided to public key registry 2224 of protocol entity 2220 for other members that are allowed to decrypt encrypted data 2228 (e.g., investor 2211 or servicer 2212). For example, any of members 2210 may choose to share their public encryption key with one or more other members.

Step 2304 includes the member(s) 2210 retrieving encryption information for nodes 2230 (e.g., or node 2232 thereof). In some embodiments, member(s) 2210 retrieves a known and trusted public encryption keys configured for node(s) 2230. For example, member(s) 2210 may retrieve the public key from public key registry 2224.

Step 2306 includes protocol entity 2220 receiving encrypted data 2228 from member(s) 2210. Accordingly, member(s) 2210 transmit encrypted data 2228 to protocol entity 2220.

Step 2308 includes protocol entity 2220 determining and transmitting instructions (e.g., determined by protocol entity instructor 2222) and encrypted data 2228 to node 2232. Protocol entity 2220 determines one or more processes that are to be executed on encrypted data 2228 and transmits instructions along with the encrypted data 2228.

Step 2310 includes node(s) 2232 executing smart contract(s) 2242 in an isolated computing environment (e.g., isolated container 2240) such as a trusted execution environment (TEE). Smart contracts 2233 are generated and maintained by protocol entity 2220. Smart contract(s) 2242 is executed in regards to encrypted data 2228, and is selected from smart contracts 2233 stored at node 2232.

Step 2312 includes node(s) 2232 decrypting encrypted data 2228 using private key 2244 and executing instructions.

Step 2314 includes nodes 2230 storing encrypted data 2234 based on smart contract(s) 2242. For example, smart contract(s) 2242 may include instructions to send encrypted data 2234 to node 2232, and other nodes of nodes 2230, for storage (e.g., as part of the blockchain).

Process 2300 includes data encryption to provide security during data processing and storage. For example, end-to-end encryption is used by protocol entity 2220 to control the access to permissioned information (e.g., cleartext data 2218), and prevent eavesdropping. In some embodiments, all data is secured using elliptic-curve cryptography to provide end-to-end encryption. In some embodiments, cleartext data 2218 is encrypted by a member of members 2210 (e.g., by originator 2214 as illustrated) desiring to propose a transaction. The member transmits encrypted information 2228 to protocol entity 2220, where encrypted data 2228 is subsequently decrypted and re-encrypted after processing (e.g., to be stored as encrypted data 2234). Members 2210 may select which participants of the blockchain system have access to their data by encrypting information with known, trusted public keys for other members (e.g., members 2210 or other members). Accordingly, a member may control their own data encryption flow since protocol entity 2220 does not own nor have access to cleartext data 2218. Protocol entity 2220 provides infrastructure and smart contracts 2233 to be executed against data. For example, a smart contract may be configured to handle due-diligence related endorsements. In some embodiments, each node of nodes 2230 (e.g., node 2232) is served from one of multiple cloud providers, guaranteeing a distributed, immutable, and trustless system.

In some circumstances, a node of nodes 2230 may be the target of an attack (e.g., a hack). In the event that a node is attacked, or otherwise compromised, the attacking entity does not have access to any data at rest (e.g., encrypted data 2234). Nodes utilize containers (e.g., isolated container 2240) that are configured to execute smart contracts within an isolated execution process. The use of an isolated computing environment isolates data being processed to a sub-container of the primary node container. In some embodiments, for example, the isolated computing environment utilizes access monitoring that will flag the process when an unauthorized root authentication occurs. When a process is flagged, it may be removed from a list of trusted nodes (e.g., its public key stored in public key registry 2224 may be de-permissioned) and any transaction-endorsement policies (e.g., as governed by protocol entity 2220). The flagging process ensures that the compromised node is no longer participating in, or receiving, transactions until protocol entity 2220 clears the “unauthorized access” flag. Accordingly, the use of an isolated computing environment, and permissioned access, helps mitigate potential attack vectors in which a hack may be performed from within the network firewall by a malicious party, or by an administrator with ill intent. End-to-end encryption may be attained at each touchpoint of transmitted and stored data. For example, referencing FIG. 22, protocol entity 2220 does not have access to cleartext data 2218 without being granted specific permission from originator 2214, who controls encryption application 2215.

In an illustrative example, there are three illustrative areas to consider for information access: submission, processing (e.g., validation), and retrieval. For example, an instance of the data may exist in each of these three areas in an unencrypted (e.g., viewable) state for an intended audience. The following description is in the context of FIG. 22, but the following description applies to any of the systems described herein (e.g., system 100 of FIG. 1 or FIG. 200 of FIG. 2, or any other system described herein).

Submission is performed by the creator and owner of the information submitted to the system (e.g., originator 2214 of FIG. 22). In some embodiments, while information may be transferred to another owner, it is impermissible to submit data to the protocol entity and not be identified as the owner of the data. In an illustrative example, for an asset that is undergoing a change in ownership, the existing owner (e.g., a member) may add a permission to the new owner (e.g., another member). The new owner may then retrieve data regarding the asset and submit data back to the protocol entity (e.g., protocol entity 2220 of FIG. 22) to finalize the change in ownership (e.g., storage as encrypted data 2234 on the blockchain). In some embodiments, a member that performs submission is able to maintain access to the submitted information by recording the asset ID and the cleartext data encryption key (e.g., storing the public key in public key registry 2224). In some embodiments, a member that performs submission is able to maintain access to the submitted information by maintaining their own private key and adding themselves to the permissioned audience. In an illustrative example, the member may be able to either maintain the asset identifier with their private key or query the system for assets with a Data Encryption Key (DEK) assigned to their public key, and then restore the cleartext DEK using their private key.

Processing is performed by nodes, with the encryption key and data handling processes strongly defined by a smart contract (e.g., smart contract 2242) and the protocol entity (e.g., protocol entity 2220). In some embodiments, the primary goals of processing are to limit the time that data spends being processed (e.g., shorter times are more secure) and to destroy keys that allow access to the data as soon as possible. In order to limit the time of, and access during, processing, for example, only a minimum number of Node Smart Contract public keys to successfully endorse a transaction are permissioned. For example, in some embodiments, only three to five total nodes out of potentially dozens have access to the information. In some embodiments, during smart contract execution, output blocks are generated using a process that removes any DEKs used for processing, thus eliminating any long-term, persisted access to the information. In some embodiments, the frequent rotation of keys by the smart contract container reduces the time window when the DEK can be retrieved. In some embodiments, the rotation process includes deleting old keys, or otherwise replaced keys, permanently. In some circumstances, access to the symmetric encryption key provides lasting and permanent access to a resource, and accordingly it is decrypted just prior to any required uses and is immediately purged after use. Because a goal of processing is to limit its duration and audience, the blockchain system may apply technical controls and monitoring to ensure no unauthorized entities are party to the transaction during processing.

Retrieval is performed by members to access stored data (e.g., encrypted data 2234 of FIG. 22) of the blockchain. For example, typically the final state of all blocks added to and stored as part of the blockchain is retrieval. In some embodiments, audience members (e.g., and their associated DEKs) are permanently committed to the blockchain (e.g., as part of a block of the blockchain), thus helping ensure a record of authorized access to stored information. In some embodiments, for example, a member may query an application programming interface (API) associated with the blockchain system to access entries by an identifier (ID) or for DEK entries that are tied to their public key (e.g., associated with previous transactions involving that member). In some embodiments, the audience associated with retrieval may be defined as the set of public keys that have a DEK recorded on the blockchain. In some embodiments, the audience for retrieval includes the owning member regardless of the presence of a DEK in the audience list because the source of the encryption is the submitting member/owner. In some embodiments, an entity that is a party to processing a transaction may be included as a party to retrieval. For example, the part may be subject to policy constraints (e.g., be limited as to what data may be accessed), temporal constraints (e.g., have a time limit or window available to access data), or both.

In an illustrative example, information committed to the blockchain may include several particular aspects. In some embodiments, a block committed to the blockchain may include an identifier that identifies the member who created the record (e.g., initiated or submitted the transaction to the protocol entity). In some embodiments, a block committed to the blockchain may include ciphertext including encrypted information based on the transaction (e.g., ownership entities, values, and other information to be included in the immutable record).

In a further illustrative example, a block that includes audience information may be committed to the blockchain. In some embodiments, a block includes a list of one or more members that constitute an intended audience. For example, the block may include one or more DEKs, associated with one or more respective members. In some embodiments, a block that includes audience information includes identifying information regarding a different block on the blockchain that includes transaction information. In some embodiments, a block that includes audience information may be committed to the blockchain after a block including transaction information is committed to the blockchain (e.g., to provide a reference point to which the audience information can reference).

In some embodiments, the blockchain system includes a Key Management Server (KMS) configured to provide an authoritative centralized location for public key storage and retrieval (e.g., as illustrated by public key registry 2224 of FIG. 22). For example, in some embodiments, the KMS maintains a registry of current and previous public keys for all members (e.g., members 2210 of FIG. 22). In some embodiments, the KMS is integrated as part of the protocol entity (e.g., protocol entity 2220 of FIG. 22). In some embodiments, public keys for members and platform infrastructure are used for creating Data Instance with Metadata and Encryption (DIME) data used to interact with other entities of the system. As an authoritative source of public keys, the KMS may control which nodes are selected for participation in smart contract processing (e.g., node 2232 of nodes 2230 is selected in FIG. 22). For example, if a node's smart contract processing public key is not included in the public key set delivered to an endpoint for DIME construction, then the resulting data cannot be decrypted by that node, thus effectively isolating it from the transaction. In some embodiments, the KMS is configured to reduce latency during processing by load balancing node requests (e.g., nodes requesting transactions to earn value tokens) and suspending processing by nodes that are offline (e.g., by excluding the offline node's public key from the public key set deliver to an endpoint). In some embodiments, the KMS is configured to suspend processing requests against nodes that have failed an active integrity monitoring process, are undergoing system administration activities, are in breach of enterprise security policies, that meet any other suitable criterion, or any suitable combination thereof

In some embodiments, the KMS is configured to assign smart contracts to nodes for execution. For example, the KMS processing-keys endpoint may be configured to generate a list of eligible smart contract instances across the network of nodes for the requested endpoint. An associated keyset may include, for example, valid public keys for each instance including the current key as well as upcoming keys to support seamless processing during key rotation. The keyset may include, for example, a time to live (TTL) that indicates how long the keyset may be cached for the processing operation before an updated version should be requested. In an illustrative example, the TTL may be based on the contents of the encrypted data, and the remaining life may be based on the shortest-lived public key in the keyset.

In some embodiments, the KMS is configured to maintain a communications connection (e.g., a TCP connection) to each node management process (e.g., an active life line to each process). For example, if this communications connection is interrupted then all of the node's smart contract container public keys are excluded by the KMS from the set of eligible processing keys immediately. In some embodiments, the communications connection continuously transmits auditing information, performance metrics, security-related monitoring data, any other suitable data, or any suitable combination thereof. In some embodiments, the KMS is configured to make load leveling decisions based on this transmitted data. For example, a security monitoring process may flag a node for suspicious activity, at which point all public processing keys for the node's smart contract will be revoked immediately. In a further example, the revocation process may include issuance of a message configured to inform entities and aspects of the system that the node is immediately banned from submitted transactions.

In some embodiments, nodes represent the primary source of entities associated with public keys managed by the KMS. In some embodiments, each node generates key pairs and publishes a public key for each of its instantiated smart contracts (e.g., smart contracts that the node processes). In some embodiments, a node maintains a communications connection to the KMS for reporting and monitoring purposes. In some embodiments, each node includes a node management application configured to manage node processes.

In some embodiments, nodes are configured to process smart contracts in an isolated computing environment scheduled by a node management process. The isolated computing environment includes an endpoint for end-to-end encryption processing (e.g., to process encrypted data from a member). For example, in some embodiments, when the smart contract is instantiated at the node, the node is configured to then initialize its encryption endpoint to generate a public and private key pair and write the public key to disk. In a further example, the public key is registered with the KMS.

In some embodiments, a smart contract instance is configured to rotate keys on a predetermined time schedule. For example, in some embodiments, the key rotation process is similar to the key pair generation process described above. In some embodiments, a configurable TTL is associated with each key pair. For example, the key TTL should be longer than the rotation interval in order to prevent an interruption in processing service by the node (e.g., from the node losing the ability to decrypt information). In some embodiments, the node smart contract instance is configured to maintain support for all valid keys. For example, until an old key expires it may still be used even if a newer key may have been published. Further to this example, the overlapping expiration/TTL of keys may provide a continuous time frame for processing (e.g., to reduce the risk of interrupting processing).

In some embodiments, the node management process is configured to monitor the integrity and performance of their computing environment. In some embodiments, the protocol entity defines functional requirements. In some embodiments, for example, the protocol entity is configured to monitor a file system, check installed software signatures, running process monitoring, and monitor system loads and available resources.

In some embodiments, the node management process maintains a continuous communications connection to the KMS. This communications connection may be used for reporting ongoing processing statistics, a security configuration status, any additional audit events defined in the node management process specification, or any suitable combination thereof. For example, if the communications connection is interrupted, then the KMS may suspend all of the node's associated keys from the list of active processing keys. The use of a continuous communication may allow the KMS to distribute load to active, secure, available, and ready node smart contract instances.

In some embodiments, the protocol entity includes a software developer kit (SDK) configured to interact with the KMS by monitoring the security event channel. For example, if a public key revocation event occurs, then a notification may be pushed out to all listeners (i.e., network entities) in order to immediately suspend the node (e.g., from processing). In some embodiments, the SDK is the mapping point between member side application requests (e.g., requests for transactions) and the nodes. Using the structure of the DIME, including DEKs associated with public keys in the audience section, the SDK may be configured to reject requests targeting the revoked node. In some embodiments, when a request is revoked, the SDK may reject the request and provide an indication that the request must be recomputed and submitted with a different set of public keys (e.g., in an audience field of the request).

In some embodiments, the protocol entity is a hosted service that members use to interact with nodes. Member computing equipment connects to the protocol entity via a secure and authenticated transport mechanism. The protocol entity proxies the member request to the appropriate nodes according to the transaction endorsement policy administered by the protocol entity (or its host). Members connect to the protocol entity using a member SDK. In some embodiments, the member may connect directly to nodes via this member SDK.

In some embodiments, cleartext data gather by a member (originator 2214 of FIG. 22) is encrypted for processing by nodes. In some embodiments, processed data is encrypted and stored in the blockchain. Encryption provides security, allowing restricted and controllable access to information. In some embodiments, the blockchain system uses an elliptic curve integrated encryption scheme (ECIES) to encrypt information for processing, for storage on the blockchain, or both. For example, the ECIES may include a key agreement (KA) function (e.g., a Diffie-Hellman key exchange), to generate a shared secret between parties. In a further example, the ECIES may include a key encapsulation method (KEM). In a further example, the ECIES may include a key derivation function (KDF). In a further example the ECIES may include a symmetric encryption algorithm (e.g., an Advanced Encryption Standard (AES) process). In a further example, the ECIES may include a message authentication code (MAC) process.

The handling of encrypted information may include encryptions, decryptions, validations, authentications, and other suitable processes, or any suitable combination thereof.

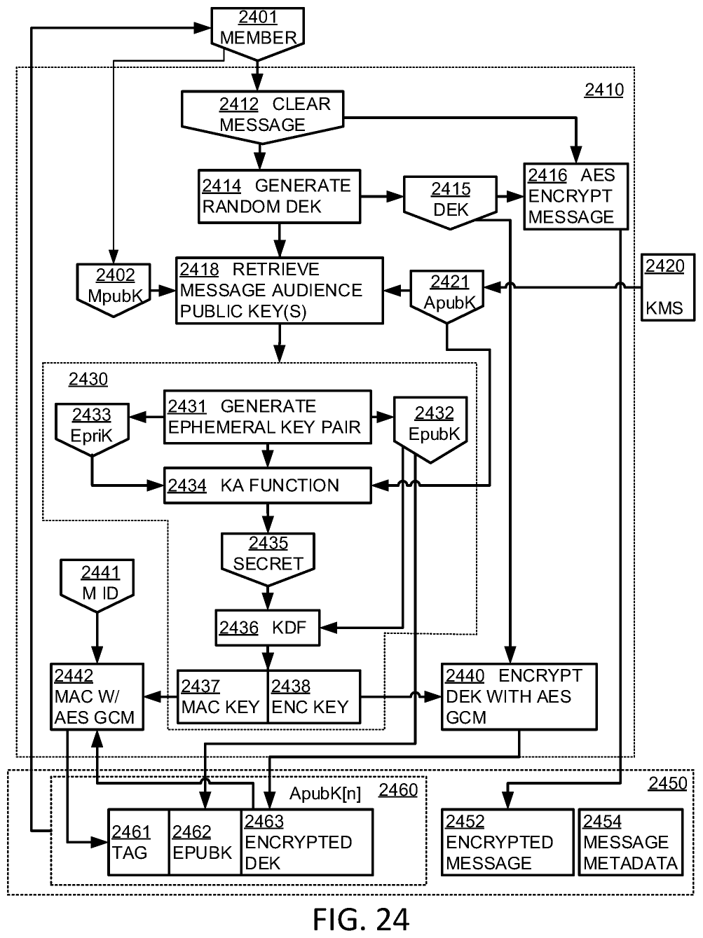

FIG. 24 shows a block diagram of an illustrative technique for encrypting information from a member, in accordance with some embodiments of the present disclosure. The technique of FIG. 24 includes an application 2410 (e.g., that includes encryption technique 2430) configured to output Data Instance with Metadata and Encryption 2450 that includes cryptogram 2460. For example, the technique of FIG. 24 includes generating a symmetric key to encrypt information from a member, and then encrypting the symmetric key to generate an encrypted payload (e.g., to then be processed by a node).

Member 2401 uses application 2410 (e.g., an SDK) to submit cleartext message 2412 for processing (e.g., and storage on the blockchain). For example, the message may include transaction information. In a further example, application 2410 may be implemented on computer equipment associated with member 2401. In some embodiments, data transmitted to the protocol entity is sent using Transport Layer Security (TLS) and is authorized using cryptographic certificates.

Application 2410 generates random, symmetric data encryption key 2415 at step 2414. Application 2410 uses DEK 2415 to encrypt cleartext message 2412 using advanced encryption standard 2416, or any other suitable symmetric cipher. Encrypted message 2452 is then configured as part of DIME 2450 (e.g. and may be decrypted by DEK 2415 subsequently). In some embodiments, member entities are able to secure their data on their own system using the protocol entity's encryption standard. For example, members may use a “Member SDK” that includes the protocol entity's encryption algorithms.

The audience members include members that are allowed to decrypt encrypted message 2452. Each audience member has an associated public key of public keys ApubK 2421 that is stored in, and recalled from, key management server 2420. For example, for a particular member, their associated public key MpubK 2402 may be used to access information. For example, application 2410 may be configured to add all allowed node public keys to the audience (i.e., ApubK 2421). It will be understood that ApubK 2421 may include one or more public keys. In some embodiments, application 2410 allows member 2401 to select audience members for the message (e.g., determine the set of ApubK 2421 associated with cleartext message 2412).

Application 2410 encrypts DEK 2415 using key generator 2430. Key generator 2430 generates a shared secret, from which an encryption key is determined. The shared secret allows a member of the Audience to decrypt DEK 2415 to subsequently decrypt message 2452. Step 2431 includes generating an ephemeral key-pair (e.g., a public key and a private key), wherein public key (“EpubK”) 2432 is derived from private key (“EpriK”) 2433. Key Agreement Function (KAF) 2434 is configured to generate secret 2435 based on EprivK 2433 and ApubK 2421. Key Derivation Function (KDF) 2436 is configured to generate Message Authentication Code key (MAC Key) 2437 and Encryption Key (ENC Key) 2438 using secret 2435 and EpubK 2432 (e.g., encoded as a byte array parameter). Step 2440 includes application 2410 encrypting DEK 2415 using a AES GCM (e.g., using ENC Key 2438), resulting in Encrypted DEK 2463.

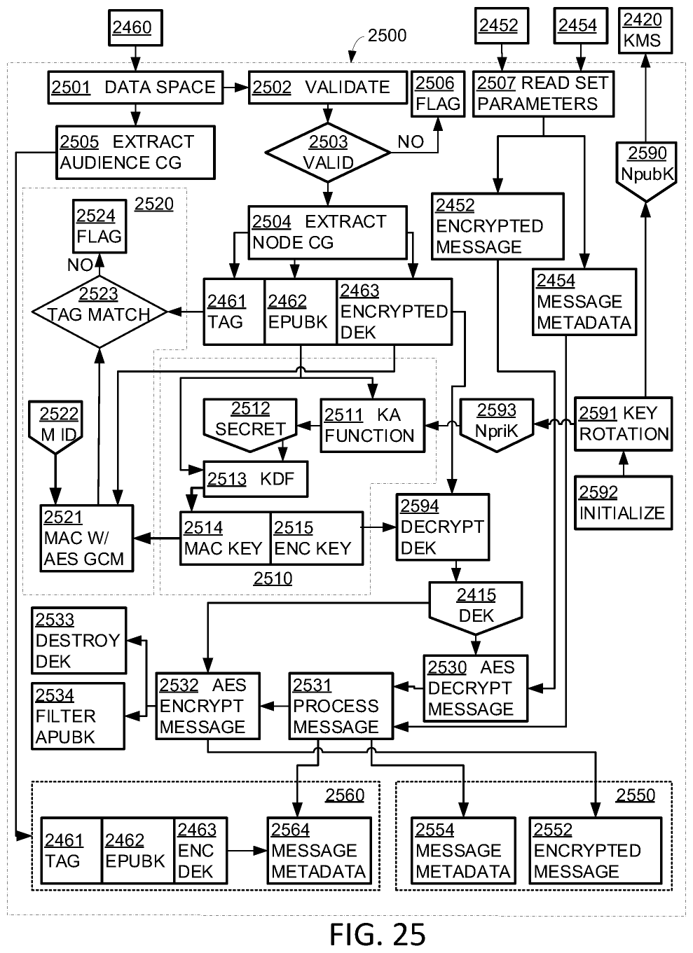

Step 2442 (e.g., a MAC function) includes application 2410 generating tag 2461 using AES GCM based on Encrypted DEK 2463, MAC Key 2437, and Member QUID 2441 as parameters. Tag 2461 includes an AES-GCM type authentication tag that may be used during a decryption validation process (e.g., as described in the context of validation process 2520 of FIG. 25).

Application 2410 generates DIME packet 2450, which includes cryptogram 2460 for each ApubK including MpubK (e.g., ApubK[n] is the nth member, with n as the index). As illustrated in FIG. 24, cryptogram 2460 includes tag 2461, EpubK 2462, and Encrypted DEK 2463, for example. DIME packet 2450 also includes encrypted message 2452 (e.g., as part of a payload block) and message metadata 2454. Message metadata 2454 includes information about DIME packet 2450 such as, for example, an asset identifier, an encryption date, key value sets, any other suitable information, or any suitable combination thereof

In some embodiments, because DEK 2415 is randomly generated at step 2414, it is stored by Member 2401 (e.g., Member 2401 does not generate DEK 2415. For example, application 2410 includes DEK 2415 in cryptogram 2460 (e.g., an ECIES cryptogram) using the Members public key (i.e., MpubK 2402) that is returned to Member 2401. In a further example, because cryptogram 2460 include encrypted DEK 2463, DEK 2415 itself (i.e., the cleartext key) is never transmitted.

In the context of FIG. 24, member 2401 submits message 2412 to the protocol entity using application 2410. Application 2410 encrypted message 2412 and created a set of audience cryptograms (e.g., cryptogram 2460 of FIG. 24). In some embodiments, an audience cryptogram set includes a list of one or more nodes that are permissioned to process message 2412 (e.g., after decrypting encrypted message 2452). In some embodiments, an audience cryptogram set includes a list of one or more additional members that are permissioned to decrypt encrypted message 2452. In some embodiments, compliance information may be inputted into the API, and included in DIME packet 2450. In some embodiments, computing equipment of member 2401 implements the encryption process that the member uses to encrypt their data before submitting it to the protocol entity. KMS 2420 in FIG. 24 may be included as part of the protocol entity hosted by computing equipment of the protocol entity, and may be used to retrieve and establish public keys that have access to the member's encrypted data.

FIG. 25 shows a block diagram of an illustrative system for processing encrypted information within smart contract 2500, in accordance with some embodiments of the present disclosure. Computing equipment associated with a node implements a process to decrypt member data during smart contract execution only. A node of the blockchain system may host, and be configured to implement, smart contract 2500. For example, the node may execute smart contract 2500 in an isolated computing environment. In some embodiments, when smart contract 2500 is installed and instantiated on a node at step 2592, smart contract 2500 creates a public-private key pair at step 2591 (e.g., a key rotation process) and publishes the public key (i.e., NpubK 2590) to a key management server (e.g., KMS 2420 of FIG. 24). Smart contract 2500 keeps the private key (i.e., NprivK 2593) in memory (e.g., of the node). In some embodiments, step 2591 is performed on a scheduled basis, wherein smart contract 2500 rotates and publishes its public key NpubK 2590.

In some embodiments, cryptogram 2460 is submitted to smart contract 2500 in transient data space 2501. Accordingly, in some embodiments, cryptogram 2460 is not persisted in the blockchain read set and therefore is not be viewable by any nodes after smart contract 2500 executes (e.g., DIME block 2560 is generated). Encrypted message 2452 and message metadata 2454 are passed to smart contract 2500 (e.g., as a parameter) and is included in the blockchain read set (e.g., as encrypted message 2552 and message metadata 2554).

In some embodiments, step 2502 (e.g., audience validation) includes smart contract 2500 using its associated public key NpubK 2590 to determine if it is included in the set of cryptograms (e.g., one of the set of cryptograms including cryptogram 2460). If smart contract 2500 is not a valid ApubK[n] cryptogram audience member, for example, then smart contract 2500 identifies the exception (e.g., generates flag 2506) and the transaction is rejected. If smart contract 2500 is not a valid ApubK[n] cryptogram audience member, for example, then smart contract 2500 extracts tag 2461, public key EpubK 2462, and encrypted DEK 2463 from cryptogram 2460 to memory (e.g., of the node).

Smart contract 2500, as illustrated, includes key generator 2510, which is configured to generate a shared secret (e.g., the same as secret 2435), from which an encryption key is determined. The shared secret is generated to decrypt encrypted DEK 2463. Smart contract 2500 uses Key Agreement Function (KAF) 2511 to generate secret 2512, which should be the same as secret 2435 used by application 2410 to encrypt DEK 2415, illustrated in FIG. 24. KAF 2511 uses public key EpubK 2462 from cryptogram 2460 and private key NprivK 2593 to generate secret 2512. Key Derivation Function (KDF) 2513 is configured to generate Message Authentication Code key (MAC Key) 2514 and Encryption Key (ENC Key) 2515 based on secret 2512 and public key EpubK 2462 (e.g., encoded as a byte array parameter).

In some embodiments, smart contract 2500 performs authentication process 2520. Step 2521 (e.g., a MAC function) includes smart contract 2500 generating a tag using AES GCM based on Encrypted DEK 2463, MAC Key 2514, and Member UUID 2522 (e.g., the same as ID 2441 of FIG. 24). Step 2523 includes smart contract 2500 comparing the resulting tag 2461 with tag 2461 of cryptogram 2460. If the tags do not match, smart contract 2500 identifies the exception (e.g., generates flag 2524) and the transaction is rejected.

Step 2594 includes smart contract 2500 decrypting encrypted DEK 2463 using encryption key 2515 (e.g., the same as ENC key 2438 or different from ENC key 2438), which generates DEK 2415. Step 2530 includes smart contract 2500 decrypting encrypted message 2452 (e.g., using AES) using DEK 2415 to generate a cleartext message (i.e., cleartext message 2412 of FIG. 24).

Step 2531 includes smart contract 2500 processing the cleartext message. Step 2531 may include, for example, message validation, message modification (e.g., appending, redacting, or otherwise changing the message), accessing message metadata 2454 (e.g. to retrieve asset ID, information about the message such as key value sets), including/altering the message based on message metadata 2454, modifying message metadata 2454 (e.g., to generate message metadata 2554), any other suitable processes, or any suitable combination thereof

Smart contract 2500 encrypts the output of step 2531, which may include a new message and metadata, with DEK 2415, thus resulting in Encrypted Message 2552. Encrypted message 2552 may be the same, or different from, encrypted message 2452. In some embodiments, following step 2532, DEK 2415 is erased at step 2533 from memory of the node and node is no longer able to decrypt encrypted message 2552 using smart contract 2500. In some embodiments, the audience cryptograms are filtered at step 2534 to remove all cryptograms for which the cryptogram type is a smart contract or node. The resulting ApubK is a set of audience cryptograms (e.g., including cryptogram 2560) containing only members that are privileged to decrypt the message. In some embodiments, smart contract 2500 generates message audience DIME 2560, which includes, for example, the filtered cryptogram set, message metadata 2564, any other suitable information, or any suitable combination thereof. DIME 2560 is written to the blockchain and is configured to provide information regarding the member permissions to data of encrypted message 2552. In some embodiments, smart contract 2500 generates DIME 2550, which includes, for example, encrypted message 2552, message metadata 2554, any other suitable information, or any combination thereof. Smart contract 2500 writes DIME 2550 to the blockchain to add to the immutable record. In an illustrative example, DEK 2415 is used to encrypt the data on the blockchain. When a DEK is transmitted it is encrypted for a predetermined audience entity by the member (e.g., originating the transaction). In some embodiments, multiple transactions may be bundled into a single block. In some embodiments, a single transaction is stored per block.

In some embodiments, smart contracts include computer program instructions that are executed based on events. For example, the event may include a document submission, a payment, a set date and time, any other suitable event, or any combination thereof. In a further example, a smart contract may include terms, agreed-upon conditions, or other information for rendering services, transferring assets, recording transactions or other activities. A smart contract may be self-executing (e.g., based on an external trigger), at a faster speed than manual processes, with less error than manual processes, and may occur at a cost savings. A smart contract may be distributed such that every node on the network includes a copy of the smart contract.

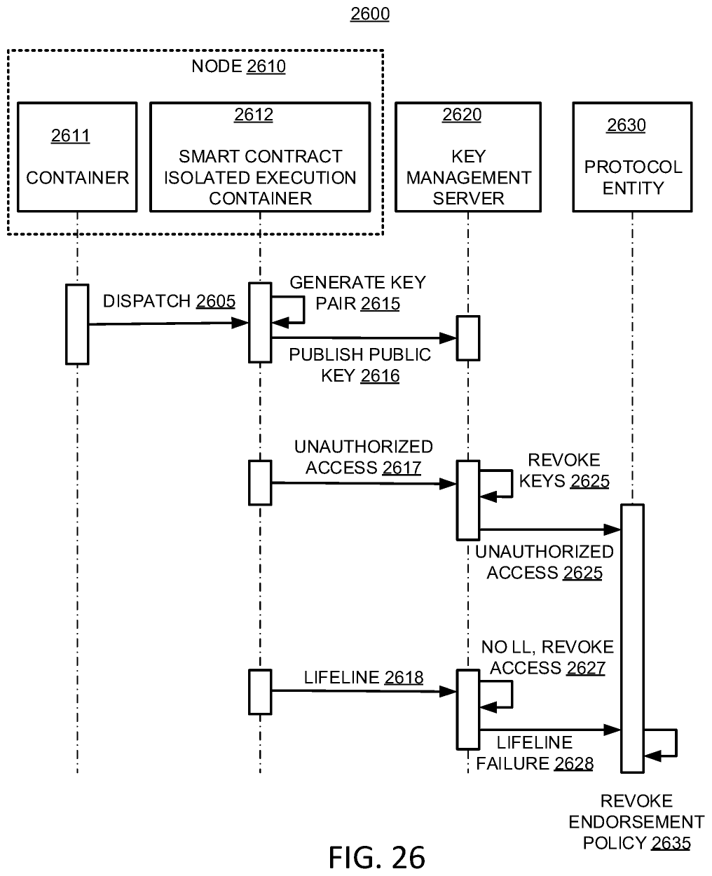

FIG. 26 shows a block diagram of illustrative arrangement 2600 for a blockchain system using an isolated computing environment, in accordance with some embodiments of the present disclosure. In illustrative arrangement 2600, processes of node container 2611 and processes of smart contract Isolated Execution container 2612 communicate with Key Management Server (KMS) 2620. The processes may communicate with KMS 2620 to, for example, publish a public key, react to unauthorized access, support a life-line ping, any other suitable action, or any suitable combination thereof. For example, if unauthorized access is detected, or KMS 2620 doesn't receive a timely life line ping from container 2612, the smart contract's keys are revoked and it is removed from ongoing smart contract transaction endorsement policies. In some embodiments, the net effect is that the smart contract cannot be executed and therefore will not receive or transmit any member transaction information.

Node 2610 executes smart contracts in isolated computing environment (e.g., o container 2612). Node 2610 may initialize or otherwise schedule (e.g., illustrated by dispatch 2605) execution of the smart contracts using a Node management process (e.g., illustrated by container 2611). In some embodiments, isolated computing environment of container 2612 includes an endpoint for end-to-end encryption processing. For example, when node 2610 initializes the smart contract (e.g., as illustrated by step 2592 of FIG. 25), node 2610 also initializes its encryption endpoint to generate a public and private key pair (i.e., during process 2615, similar to step 2591 of FIG. 25), holding the private key (e.g., similar to NpriK 2593) in protected memory and writing the public key to disk during process 2616. The public key is collected by a process of container 2612 and registered with KMS 2620 during process 2616. The use of the public key helps ensure that data processed in the isolated computing environment is transferred as encrypted.

In some embodiments, the processes running in the isolated computing environment utilize access monitoring (i.e., process 2617), life-line monitoring (i.e., process 2618), or both. For example, access monitoring may include generating a flag when an unauthorized root log-on occurs. When a process is flagged, for example, it is removed from the list of nodes permissioned for processing (e.g., the list stored in a KMS) and any transaction endorsement policies. Process 2625 includes KMS 2620 revoking the public key of node 2610 if unauthorized access is detected (i.e., process 2617). In a further example, continuous life-line connection monitoring (i.e., process 2618) is used for reporting ongoing processing statistics, security configuration status, any other suitable audit events defined in the node management process specification, or any combination thereof. To illustrate, a TCP connection may be used for communication, and the TCP connection itself must be continuously maintained against KMS 2620. If this connection is interrupted, for example, the KMS may be configured to suspend all of the node's associated keys from the list of active processing keys. For example, process 2627 includes KMS 2620 revoking a public key of node 2610 in response to loss of the life-line (e.g., an interruption of process 2618). In a further example, if the life-line is lost, KMS 2620 communicates the failure to protocol entity 2630 during process 2628. In some embodiments, in response to process 2628, protocol entity 2630 revokes an endorsement policy for node 2610 (e.g., and node 2610 is not permissioned for further transactions until further determinations by protocol entity 2630).

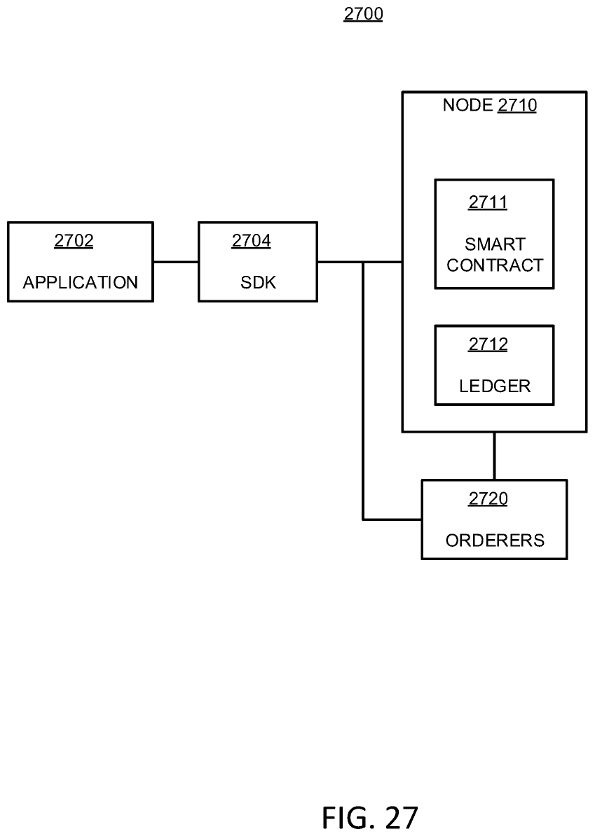

FIG. 27 shows a block diagram of illustrative arrangement 2700 for transacting using a blockchain system, in accordance with some embodiments of the present disclosure. Arrangement 2700 may be used to, for example, add information to the blockchain with consensus.

A member may use application 2702 (e.g., an API) to invoke the blockchain system to query or update the blockchain ledger using SDK 2704. In some embodiments, SDK 2704 connects to a predetermined set of one or more nodes (e.g., node 2710) using, for example, the member's enrollment information and transport layer security (TLS). In some embodiments, SDK 2704 invokes smart contract 2711 on all nodes (e.g., including node 2710) in the network based on the function the member application is invoking, for example. For example, the invocation may include a proposal to update ledger 2712.

In some embodiments, smart contract 2711 is configured to query, update, or otherwise interact with ledger 2712 via a simulation. In some such embodiments, the simulation is executed on all nodes of the network. In some embodiments, the simulated update to ledger 2712 is communicated to SDK 2704. SDK 2704 may assemble the simulated updates and check them for consistency (e.g., all nodes returning the same result). If, for example, the simulated updates are inconsistent, then SDK 2704 may throw an exception (e.g., generate a flag) and accordingly, the transaction stops. If, for example, simulated updates are consistent, SDK 2704 may submit the transactions to orderers 2720 for ordering and consensus.

In some embodiments, orderers 2720 validate that endorsement policies, digital signatures, transactions, and other aspects of the transaction are valid. In some embodiments, orderers 2720 submit the simulated update to all nodes (e.g., including node 2710) who participate in maintaining and updating ledger 2712. d. For example, each node commits the block to its blockchain ledger (e.g., the simulated update is now an actual update). In some embodiments, the transaction is published and SDK 2704 transmits information regarding the event to application 2702 (e.g., accessible by the invoking member).

The blockchain-based systems of the present disclosure include a plurality of nodes, members, and other network entities. Authentication of a network entity's identity may be performed using digital signatures, for example. In some embodiments, an elliptical curve digital signature algorithm (ECDSA) is used to provide authentication. For example, ECDSA digital signatures including a FIPS-186-4 standard elliptic-curve digital signature algorithm) may be used.

In some embodiments, before an ECDSA authenticator can function, a private key must be determined. A corresponding public key is derived from the private key and one or more domain parameters. The key pair (i.e., public and private keys) are stored in the authenticator's memory, for example. In some embodiments, the private key is not accessible from or to other network entities, while the public key is openly accessible to other network entities. In some embodiments, nodes utilize an Intermediate Certificate Authority (ICA) that is created by the protocol entity to generate ECDSA enrollment key pairs. The ICA provides a chain of trust for all network entities of the platform.

A digital signature allows a recipient of a message to verify the message authenticity using the authenticator's public key. For example, a variable-length message is converted to a fixed-length message digest (e.g., h(m)) using a secure hash algorithm. For example, a secure hash includes properties such as irreversibility (e.g., it is computationally infeasible to determine the message from its digest), collision resistance (e.g., it is impractical to find more than one message that produces a given digest, high avalanche effect (e.g., any change in the message produces a significant change in the digest), among other properties. In some embodiments, after the message digest is computed, a random number generator is activated to provide a value k for elliptic curve computations.

A signature verification is the counterpart of the signature computation. In some embodiments, signature verification is used to check the message authenticity using the authenticator's public key. For example, using the same secure hash algorithm as in the signature step, the message digest signed by the authenticator is computed which, together with the public key and the digital signature components, leads to the result (e.g., authentication).

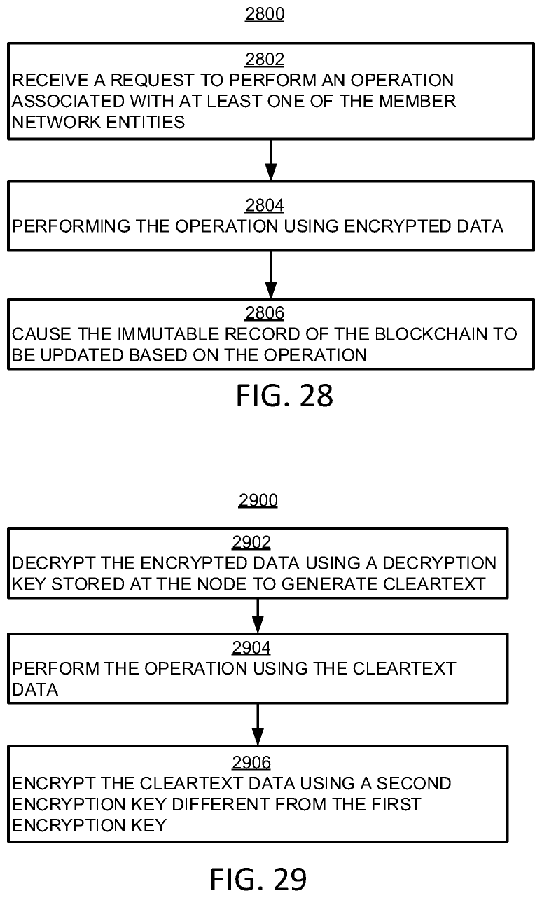

FIG. 28 shows a flowchart of illustrative process 2800 for managing an operation of a blockchain system, in accordance with some embodiments of the present disclosure.

Step 2802 includes the protocol entity receiving a request to perform an operation associated with at least one member network entity. For example, in the context of FIG. 24, step 2802 may include application 2410 receiving cleartext message 2412. A member may submit a transaction request to the protocol entity using an application programming interface, defined by a software developer kit of the protocol entity. The member may submit the message as cleartext, as well as a list of other members that are permissioned to access the message.

Step 2804 includes performing the operation of step 2802 using encrypted information. For example, in the context of FIGS. 24-25, application 2410 encrypts the message, and smart contract 2500, enacted on a node, processes the message to perform the operation. The node is configured to execute the smart contract in an isolated computing environment.

Step 2806 includes causing the immutable record of the blockchain to be updated based on the operation. For example, in the context of FIG. 25, smart contract 2500 updates the immutable record with DIME 2550 and DIME 2560. The node writes one or more blocks to the blockchain to update the immutable record, based on the smart contract.

FIG. 29 shows a flowchart of illustrative process 2900 for performing an operation in an isolated computing environment, in accordance with some embodiments of the present disclosure. For example, in some embodiments, step 2804 of FIG. 28 includes performing process 2900.

Step 2902 includes decrypting the encrypted data using a decryption key stored at the node to generate cleartext. For example, in the context of FIG. 25, smart contract 2500 determines DEK 2415 to decrypt encrypted message 2452 at step 2530. The node may execute a smart contract that generates the decryption key (e.g., using ECIES), and authenticates the message (e.g., process 2520 of FIG. 25).

Step 2904 includes performing the operation using the cleartext of step 2802. For example, in the context of FIG. 25, smart contract 2500 processes the decrypted message at step 2531. The operation may include, for example, adding to the message, redacting the message, altering the message, generating metadata, any other suitable processes, or any combination thereof.

Step 2906 includes encrypting the cleartext data using a second encryption key different from the first encryption key.

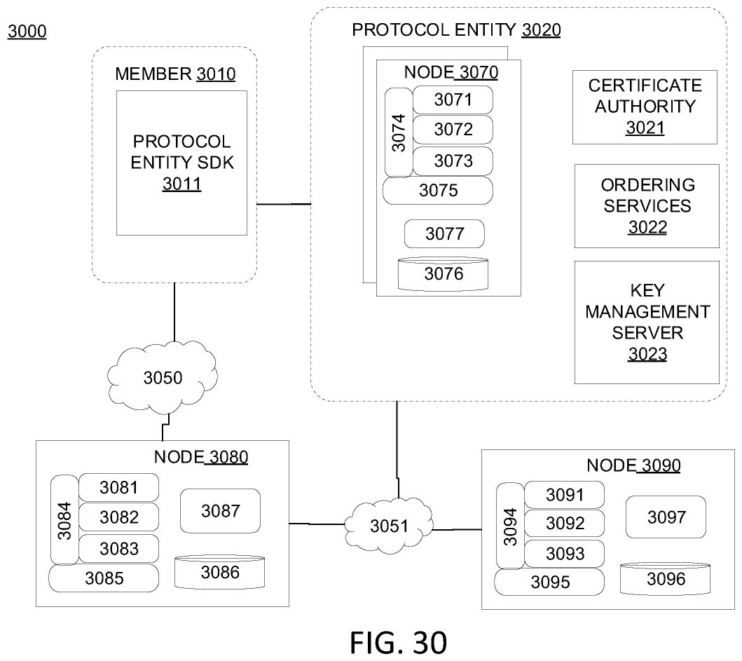

FIG. 30 shows a block diagram of illustrative network arrangement 3000 for a blockchain system, in accordance with some embodiments of the present disclosure. Member 3010 hosts SDK 3011 and is configured to communicate with protocol entity 3020 and node 3080. Node 3090 is configured to communicate with protocol entity 3020 and node 3080. The communications network may include network 3050 and network 3051.

Node 3070 includes loan ledger 3071, asset ledger 3072, hash ledger 3073, smart contracts 3074, peer-to-peer block gossip 3075, file system 3077, ledger database 3076, and may also include any other suitable components, or any combination thereof. Node 3080 includes loan ledger 3081, asset ledger 3082, hash ledger 3083, smart contracts 3084, peer-to-peer block gossip 3085, file system 3087, ledger database 3086, and may also include any other suitable components, or any combination thereof. Node 3090 includes loan ledger 3091, asset ledger 3072, hash ledger 3093, smart contracts 3094, peer-to-peer block gossip 3095, file system 3097, ledger database 3096, and may also include any other suitable components, or any combination thereof. Protocol entity 3020 includes certificate authority 3021 (e.g., for authentication), ordering services 3022 (e.g., for disclosure and compliance information), key management server (KMS) 3023 (e.g., for managing encryption keys), and node 3070 (e.g., used to provide resiliency). For example, ordering service 3022 may include an orderer cluster, a Kafka cluster, or both. In a further example, certificate authority 3021 may include a CA cluster, ICA cluster, or both. In a further example, KMS 3023 may include a KMS cluster.

In some embodiments, member 3010 may communicate with protocol entity 3020 (e.g., using TLS and gRPC remote procedure call) to commit a request (e.g., in either direction), receive communication of events, and receive keys (e.g., from KMS 3032). In some embodiments, member 3010 may communicate with mode 3080 regarding endorsement requests, receiving communication of events, any other suitable communication, or any combination thereof. In some embodiments, node 3080 may communicate with node 3090 (e.g., using TLS and gRPC remote procedure call).

In some embodiments, the protocol entity is a hosted service that members use to interact with nodes. For example, member computing equipment may connect to the protocol entity via a secure and authenticated transport mechanism. The protocol entity proxies the member request to the appropriate node(s) according to the transaction endorsement policy administered by the protocol entity. Members communicate with the protocol entity using a member SDK, which connects to the protocol entity. In some embodiments, a member may communicate with nodes via the member SDK. In some embodiments, the protocol entity includes a cloud service deployed on virtual hardware at a cloud provider. In some embodiments, the protocol entity is only hosted by an entity and is not distributed to members for execution on their computing equipment.

In some embodiments, the blockchain system provides transparency, significant cost reduction, reduced risk and enhanced security by not relying on trusted entities but rather current information and permissions. For example, access to real time data and full validation of a loan provides transacting parties necessary diligence and confirmation that assets being transacted exist, are properly underwritten, are enforceable, and are free and clear of liens. To illustrate, reliance on third parties to provide diligence may cause additional costs and delays, and might not address many of the risks that are commonly related to transacting in loans. Accordingly, buyers need not rely on representations and warranties to provide further protection in the event of a loss. The blockchain systems described herein may help reduce reliance on representations and warranties, provide real-time visibility to the asset, and allow the parties to transact based on truth instead of trust. In some circumstances, an onboarding process discloses all exceptions and inconsistencies in underwriting, missing documents, disclosures or signatures in the loan file. In some embodiments, loan servicing and payments are executed on the blockchain system in real time. For example, loan owners and buyers may have full transparency into loan performance on a daily basis. In some embodiments, servicing remittances are automatically sent to the owner on record without further instruction. Each principal and interest payment is associated with the loan, which references the owner and their account. Accordingly, there may be no need for a loan servicer to reconcile principal and interest payments, and further, remittances can be made daily. In some embodiments, loan servicers need not board and offboard loans in the event of a servicing transfer. For example, if ownership changes, borrowers don't need to change where they send payments. To illustrate, payments may be recorded in the immutable database and remitted to the owner. Accordingly, post-closing servicing transfer may be more efficient and need not cause payment delinquency due to borrowers sending money to the wrong servicer. In some embodiments, loan validation and transparency of the loan performance may help reduce the need to rely on representations and warranties as a risk mitigant/loss allocation. In some circumstances, many processes are performed and then repeated over and over during the life of a loan. In addition, data from third parties is rarely capable of being consumed and aggregated into a single source or repository, limiting the full transparency into an asset. In some embodiments, all relevant loan documents and information are available to the owner. In some embodiments, only the party indicated as the owner has the right to exercise control over the loan (e.g., selling, pledging, permissioning). For example, when loans are originated and onboarded to the blockchain system, loans are validated and exceptions, if any, are noted. In a further example, any party permissioned to view the loan data has visibility to the contents of the loan file and exceptions.

In some embodiments, loan validation includes re-underwriting every loan, reviewing loan file contents, disclosures, and signatures, reviewing notarization, identity verification, and fraud checks. Additionally, exceptions may be noted and made transparent to the current loan owner and any future loan owner, meaning there is no need for most origination or loan performance representations. In some circumstances, there is no need to continuously perform diligence for the life of a loan. For example, the chain of custody (e.g., stored in the blockchain) allows all previous diligence performed on the loan to be visible to all future owners. In some embodiments, payments are recorded in the immutable database as they are received. For example, the loan servicing/payment history is transparent and buyers need not rely on the servicer for access to data or performance status. To illustrate, buyers may know the current status of each loan at the time of purchase. In some embodiments, since payments are recorded using the blockchain system in real time, investors receive principal and interest payments the day after settlement, for example. To illustrate, there is no need to wait for a monthly remittance date. In some embodiments, investors receive the full benefit of the float from loan payments, instead of the servicer receiving ancillary income until the monthly remittance date. In some embodiments, the blockchain system is the system of record and exchange, and there is no need to update a separate system such as MERS to reflect a change of ownership (e.g., of mortgage notes). For example, a receipt of purchase automatically updates the buyer's ownership of the loan via a smart contract. In some embodiments, the use of a blockchain system allows operations to be streamlined. For example, many manual processes (e.g., trade confirmations, review of exceptions, updating jotters, reconciliations of remittance reports) are automated via one or more smart contracts, thus reducing the need for operational resources. In some embodiments, risks related to intraday funding, manual process administration, improper wire instructions, fraud, data loss, any other risks are mitigated by the blockchain system. In some embodiments, because the blockchain system serves as the one system of record, loans cannot be double pledged. For example, when loans are pledged using the blockchain system, the pledging of the loan is immutably recorded. In a further example, the blockchain system does not allow a pledged loan to be pledged to another party. In some embodiments, the blockchain system is significantly less vulnerable to data tampering and loss, because identical data is stored across multiple nodes. For example, data generated from transactions on the blockchain system is securely distributed across multiple sites, countries and institutions. Multiple nodes on the network hold encrypted, distributed copies of the ledger at all times. If a node attempted to alter any of the existing data, the protocol entity would immediately recognize the discrepancy and remove that node from the network. To illustrate, the remaining nodes are required to reach a consensus by majority rules. In some embodiments, an asset ledger is updated in real time, and thus an investor has immediate visibility into their holdings and a warehouse lender knows exactly what assets and payments have settled without having to wait until the end of the day.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A method for securely performing an operation in a node of a blockchain system, the blockchain system comprising
a plurality of nodes of which the node is one, each of the plurality of nodes comprising:
respective node computing equipment comprising node storage equipment, and
respective node communications equipment;
a plurality of member network entities, each of the plurality of members comprising respective member computing equipment,
a protocol entity comprising protocol entity computing equipment, and
a computer network coupling the nodes, the member network entities, and the protocol entity, wherein each respective node storage equipment of the plurality of nodes together are configured to maintain an immutable record as a blockchain,
the method comprising:
receiving at the node, using the node communications equipment, from the protocol entity, a request to perform an operation associated with at least one of the plurality of member network entities,
performing, in an isolated computing environment of the node using node computing equipment, the operation using encrypted data stored in node storage equipment of the node, wherein the encrypted data was encrypted using a data encryption key, and wherein performing the operation comprises:
decrypting, using the node computing equipment, the encrypted data to generate cleartext data,
performing, using the node computing equipment, the operation based on the cleartext data, and
encrypting, using the node computing equipment, the cleartext data; and
causing the immutable record of the blockchain to be updated based on the operation.

2. The method of claim 1, further comprising validating the operation with the blockchain.

3. The method of claim 1, wherein the isolated computing environment comprises a trusted execution environment.

4. The method of claim 1, further comprising receiving the encrypted data from the at least one of the member network entities.

5. The method of claim 1, wherein the data encryption key comprises a symmetric key.

6. The method of claim 1, wherein decrypting the encrypted data comprises:
receiving an encrypted data encryption key from the at least one of the plurality of member network entities;
decrypting the encrypted data encryption key based on a key to generate the data encryption key; and
decrypting the encrypted data based on the data encryption key.

7. The method of claim 1, wherein performing the operation comprises executing a transaction according to a protocol defined by the protocol entity.

8. The method of claim 1, further comprising determining whether the node is permissioned to perform processing based on at least one of the group: an on-going transmission by the node over a communication link, an authentication of the node, and both.

9. The method of claim 1, wherein causing the immutable record of the blockchain to be updated based on the operation further comprises:
adding a first block comprising the secured data to the blockchain; and
adding a second block comprising audience information to the blockchain, wherein the audience information comprises a list of permissioned entities.

10. The method of claim 1, further comprising generating a simulated update of the immutable record of the blockchain, wherein causing the immutable record of the blockchain to be updated is further based on the simulated update.

11. A node of a blockchain system for securely performing an operation, the node comprising:
node computing equipment comprising node storage equipment;
node communications equipment for communicatively coupling over a computer network to a plurality of member network entities, a protocol entity, and at least one other node comprising respective node computing equipment, which comprise respective other node storage equipment, wherein each of the node storage equipment and respective other node storage equipment of the at least one other node are together configured to maintain an immutable record as a blockchain,
and wherein the node communications equipment is configured to receive from the protocol entity a request to perform an operation associated with at least one of the plurality of member network entities,
and wherein the node computing equipment is configured to:
perform, in an isolated computing environment, the operation using encrypted data stored in the node storage equipment, wherein the encrypted data was encrypted using a data encryption key, and wherein configured to perform the operation comprises being configured to:
decrypt the encrypted data to generate cleartext data,
perform the operation based on the cleartext data, and
encrypt the cleartext data; and
cause the immutable record of the blockchain to be updated based on the operation.

12. The node of claim 11, wherein the node computing equipment is further configured to validate the operation with the blockchain.

13. The node of claim 11, wherein the isolated computing environment comprises a trusted execution environment.

14. The node of claim 11, wherein the the node communications equipment is further configured to receive the encrypted data from the at least one of the member network entities.

15. The node of claim 11, wherein the data encryption key comprises a symmetric key.

16. The node of claim 11, wherein the node communications equipment is further configured to receive an encrypted data encryption key from the at least one of the plurality of member network entities, and wherein the node computing equipment is further configured to:
decrypt the encrypted data encryption key based on a key to generate the data encryption key; and
decrypt the encrypted data based on the data encryption key.

17. The node of claim 11, wherein the node computing equipment is further configured to execute a transaction according to a protocol defined by a protocol entity.

18. The node of claim 11, wherein the node computing equipment is further configured to determine whether the node is permissioned to perform processing based on at least one of the group: an on-going transmission by the node over a communication link, an authentication of the node, and both.

19. The node of claim 11, wherein the node being configured to cause the immutable record of the blockchain to be updated based on the operation comprises the node being configured to:
add a first block comprising the secured data to the blockchain; and
add a second block comprising audience information to the blockchain, wherein the audience information comprises a list of permissioned entities.

20. The node of claim 11, wherein the node computing equipment is further configured to generate a simulated update of the immutable record of the blockchain, wherein the node computing equipment is further configured to cause the immutable record of the blockchain to be updated based on the simulated update.

21. A non-transitory computer readable medium having instructions programmed thereon for performing a method for securely performing an operation in a node of a blockchain system comprising:
a plurality of nodes of which the node is one, each of the plurality of nodes comprising respective node computing equipment comprising node storage equipment,
a plurality of member network entities, each of the plurality of members comprising respective member computing equipment,
a protocol entity comprising protocol entity computing equipment, and
a computer network coupling the nodes, the member network entities, and the protocol entity, wherein each respective node storage equipment of the plurality of nodes together are configured to maintain an immutable record as a blockchain,
the method comprising:
receiving from the protocol entity, at the node, a request to perform an operation associated with at least one of the plurality of member network entities,
performing, in an isolated computing environment of the node, the operation using encrypted data stored in node storage equipment of the node, wherein the encrypted data was encrypted using a data encryption key, and wherein performing the operation comprises:
decrypting the encrypted data to generate cleartext data,
performing the operation based on the cleartext data, and
encrypting the cleartext data; and
causing the immutable record of the blockchain to be updated based on the operation.

22. The non-transitory computer readable medium of claim 21, wherein the method further comprises validating the operation with the blockchain.

23. The non-transitory computer readable medium of claim 21, wherein the isolated computing environment comprises a trusted execution environment.

24. The non-transitory computer readable medium of claim 21, wherein the method further comprises receiving the encrypted data from the at least one of the member network entities.

25. The non-transitory computer readable medium of claim 21, wherein the data encryption key comprises a symmetric key.

26. The non-transitory computer readable medium of claim 21, wherein decrypting the encrypted data comprises:
receiving an encrypted data encryption key from the at least one of the plurality of member network entities;
decrypting the encrypted data encryption key based on a key to generate the data encryption key; and
decrypting the encrypted data based on the data encryption key.

27. The non-transitory computer readable medium of claim 21, wherein performing the operation comprises executing a transaction according to a protocol defined by the protocol entity.

28. The non-transitory computer readable medium of claim 21, wherein the method further comprises determining whether the node is permissioned to perform processing based on at least one of the group: an on-going transmission by the node over a communication link, an authentication of the node, and both.

29. The non-transitory computer readable medium of claim 21, wherein causing the immutable record of the blockchain to be updated based on the operation further comprises:
adding a first block comprising the secured data to the blockchain; and
adding a second block comprising audience information to the blockchain, wherein the audience information comprises a list of permissioned entities.

30. The non-transitory computer readable medium of claim 21, wherein the method further comprises generating a simulated update of the immutable record of the blockchain, wherein causing the immutable record of the blockchain to be updated is further based on the simulated update.
